(19) United States
(12) Patent Application Publication
(10) Pub. No.: US 2009/0210245 A1
(43) Pub. Date: Aug. 20, 2009

(54) Drawing and data collection systems

(76) Inventor: Edwin Leonard Wold, Mesa, AZ (US)

Correspondence Address: Edwin Wold, 3746 E. Covina St, Mesa, AZ, 85205, US

(21) Appl. No.: 12/317,540

(22) Filed: Dec. 24, 2008

Related U.S. Application Data
(60) Provisional application No. 61/009,417, filed on Dec. 28, 2007.

(51) Int. Cl. G06Q 10/00; G06F 17/30; G06G 7/48; G06F 15/18

(52) U.S. Cl. 705/1; 707/5; 703/6; 706/12; 707/E17.018; 707/E17.03

(57) ABSTRACT

An apparatus, system and method is disclosed herein for searching and retrieving data in the form of text and images that may be used for designing and drawings applications in industry and for crime investigation and prevention. Data is retrieved from databases optionally using a statistical profiler and observations/hunch notes to filter and narrow the search. The present invention may serve as a simulation tool, as a storage system, as a legal presentation system and as a calculation program.

### CROSS-REFERENCE TO RELATED APPLICATION

The present application is related to and claims priority from prior provisional application Ser. No. 61/009,417, filed Dec. 28, 2007, entitled “DRAWING TEMPLATE COLLECTION”, the contents of which are not admitted to be prior art with respect to the following invention by mention in this cross-reference section.

### BACKGROUND OF THE INVENTION

1. Technical Field

The present invention relates generally to the field of image storage and retrieval and more specifically relates to the efficient search, retrieval and reference of relevant images stored in image libraries, to be used within a drawing template system for creating industry specific drawings and performing and organizing investigations.

2. Description of Related Art

Technology has dramatically increased the availability and amount of information available electronically, however the limitations for efficient searching and retrieval of relevant information has become a formidable challenge to individuals and industry personnel. There is a need for an efficient system to make images and industry-specific drawings readily available to the public for reference.

Persons are quite often able to visualize a drawing in their head, but find it difficult to accurately reproduce the image or idea to a medium having the correct perspective and proportion, including all the necessary details that the drawing may be easily understood by others. Drawings are most often industry-specific and use a ‘visual jargon’, that others not knowledgeable in the specific industry have difficulty understanding.

The vast majority of industrial drawings and images must be drawn manually or by using a computer drafting program, according to industry-specific specifications, to be efficiently recognized. Manual drafting is very labor intensive and is not conducive to efficient reproduction. Many computer drafting programs are design-specific for use in only one industrial application or another and may require vast amounts of training to operate. Drawings not drawn accurately may create problems during the design and subsequent building stages. Delays from poor drawings may also create inefficiencies and cost over-runs. Further, dangers may exist if drawings are created with the wrong industry symbols creating the potential for imprecision within the design and/or build process.

The inadequacies of present drawing systems and present image retrieval systems extend into the field of investigation. Problems that are experienced dealing with smaller individual drawing files are amplified when multiple drawings, references and data are obtained from multiple functional areas. Ideally, these disparate files would be condensed into a comprehensive electronic file that was logically organized and suitable for use by a layman user. Presently, files are typically in printed form, are stored in various locations and are therefore susceptible to being misplaced, and/or having the evidence compromised. Typical filing systems may be inefficient because they are not comprehensive, nor readily available to be referenced during the course of an investigation.

Investigators and attorneys collecting or disseminating evidence for use in prosecuting and defending persons accused of various crimes may use programs such as QuickTime VR. QuickTime VR is an example of a type of image file format program and is supported by Apple's QuickTime. The program allows the creation and viewing of photographically captured panoramas and the exploration of objects through images taken at multiple viewing angles. The program may function as a plugin for the QuickTime Player or may alternately work as a QuickTime Web browser plugin. QuickTime VR will play on Apple and Windows platforms. VR Panoramas are used with panoramic images which surround the viewer with an environment, inside, looking out, yielding a sense of place. They can be “stitched” together from several normal photographs or two images taken with a circular fisheye lens, or captured with specialized panoramic cameras, or rendered from 3D-modeled scenes.

Previous approaches to crime investigation, documenting and evidence tracking have been limited in scope, efficiency and reliability thereby limiting effective case solving. Industry-specific drawing programs may be expensive and require special training to manipulate thereby restricting the layman's ability to transfer mental images to a hardcopy.

Thus, a need exists for the drawing template and investigation system to create a cost-effective, efficient, reliable system to reference, organize, and draw and to avoid the above-mentioned problems. Ideally, a drawing template and investigation system should operate reliably and efficiently with a minimum of training and be manufactured at a modest expense.

### BRIEF SUMMARY OF THE INVENTION

The present invention holds significant improvements and serves to meet the above-mentioned needs as a drawing template and investigation system. An drawing and data collection system is disclosed herein comprising: at least one computer system; at least one inputter; at least one internet communicator, a connection means to the internet by hardwired or wireless means or other; at least one database comprising at least one security tier and at least one data; at least one statistical profiler. The inputter may be a mouse, lightpen, keyboard or other that is connected to the computer system and permits at least one user to input data into the computer system which is connected by the at least one internet communicator to the at least one database. The database comprises data that may be searchable by the user by having authorized access to the at least one security tier. The statistical profiler ranks data according to programmed profiles using weighted statistical links to databases and filters output search data to output at least one image.

The drawing and data collection system acting as an image retrieval and referencing system may be used to investigate at least one crime using observations/hunch notes recorded at the crime scene. As well, the drawing and data collection system may be used to search and retrieve at least one industry-specific drawing. The drawing and data collection system may further comprise at least one crime definitions database for use in searching, preparing, organizing and presenting at least one legal case. The drawing and data collection system may find use in combination with at least one virtual globe-map-geographic information program to create at least one simulation of at least one scenario, crime or industrial or other.

The databases may comprise investigative databases and information comprising: at least one print/impression databases including, at least one footprint database, at least one bite-mark/odontology database, at least one fingerprint database, at least one tool-mark database, at least one tire-tread database, and at least one forensic document examination database; at least one weapon databases further comprising, at least one gun registry database, at least one ballistics database, at least one gunpowder residue information/results, and at least one knife and hand tool database; at least one individual information database, at least one social security number database, at least one terrorist activities database, at least one criminal history database, at least one photograph database, at least one suspect database, at least one family tree database, at least one phone/utility record information, at least one voice signature database, economic activity database, crime family/gang database, life insurance policy database, at least one statement; at least one driver's license database, at least one DNA profile database, at least one tattoo database, at least one hospital records, at least one passport/immigration database, at least one missing persons database, at least one street names database, and at least one sex-offender database; at least one vehicle information databases further comprising, at least one vehicle specifications database, and at least one traffic ticket database; at least one forensic anthropology/medical examiner database; at least one forensic archaeology database; at least one forensic psychology database; at least one crime definitions database comprising charting and presentation options; at least one timeline; at least one physics/mathematical formula database; at least one chemical database; at least one electronic/computer evidence database; at least one location information databases further comprising, at least one geographical map overlay, at least one topographical overlay, at least one distance overlay, at least one GPS locator, and at least one virtual globe-map-geographic information program; at least one crime-scene photos; at least one crime scene video; all preferably linked with at least one linker to at least one statistical profiler and at least one observations/hunch notes.

The drawing and data collection system preferably uses databases that are linked with linker acting as at least one hub according to at least one probability.

The drawing and data collection system preferably further comprises at least one overlay procedure means wherein images may be referenced against database images, able to be layered seeing through all or some of the layers.

The statistical profiler of the drawing and data collection system retrieves the data available to the public using at least one search bot or web crawler.

The drawing and data collection system preferably comprises a physics/mathematical formula database which may be used to input numerical values to simulate a crime using images and a virtual globe-map-geographic information program.

The drawing and data collection system may be used to download a photograph from the photograph database and display photograph(s) in or as at least one photo lineup whereby at least one witness may verify making at least one identification using a fingerprint signature. The witness may be able to flip through a series of the photographs in a tiled orientation.

The drawing and data collection system wherein a statement may be compared against another statement and the similarities are visually highlighted using at least one color change in the test. A family tree database and crime family/gang database may comprise a set of layered flowcharts that show at least one relationship that may have various layers turned off or on. The drawing and data collection system wherein the economic activity database is used to monitor passport/immigration database to limit terrorist activities, gang activities and criminal gain. The software of the drawing and data collection system is preferably programmed using at least one operating system independent platform.

A method of using the drawing and data collection system of the present invention is described herein, comprising the steps of: entering input data into a computer to search and retrieve at least one output data from at least one tiered security database, wherein the data may be image or text; analyzing the output data to determine its relevance; downloading the output data to use in at least one design or investigation; wherein the output data may be used to create at least one crime simulation. The method of using the drawing and data collection system may further comprise the step of filtering the at least one output data from tiered security database through a programmed statistical profiler and may further comprise the step of narrowing the search using observations/hunch notes.

An accident investigation kit is disclosed for vehicular accidents comprising: a digital camera; a notebook; a user-instruction manual, and wherein the digital camera is used to document an accident scene and the notebook is provided to enter information from the scene and the user instruction manual is provided to guide the user in documenting the accident scene.

### BRIEF DESCRIPTION OF THE DRAWINGS

The preferred embodiments of the present invention will hereinafter be described in conjunction with the appended drawings, wherein like designations denote like elements.

FIG. 1 shows a perspective view, illustrating a drawing and data collection system, according to a preferred embodiment of the present invention.

FIG. 1A shows a flowchart of databases in the database system, as linked, using a linker in the drawing and data collection system, according to a preferred embodiment of the present invention.

FIG. 2 illustrates the linking of databases of the drawing and data collection system, as used with statistical profiler, according to a preferred embodiment of the present invention of FIG. 1.

FIG. 3 is a perspective view illustrating the drawing and data collection system, as used to compare crime data, to search using statistical profiler, according to a preferred embodiment of the present invention of FIG. 1

FIG. 4 is a perspective view illustrating a timeline and illustrating use of certain features of a location information database of drawing and data collection system, according to a preferred embodiment of the present invention of FIG. 1.

FIG. 5 shows a virtual simulation of a virtual globe-map-geographic information program and a photo line-up of drawing and data collection system, according to a preferred embodiment of the present invention of FIG. 1.

FIG. 6 shows an accident investigative kit, for use in vehicular accidents, according to a preferred embodiment of the present invention of FIG. 1.

FIG. 7 shows options of a statement, using comparison and highlighting discrepancies and using options within a crime definitions database to organize, prepare and present a case using the drawing and data collection system, according to a preferred embodiment of the present invention of FIG. 1.

FIG. 8 illustrates the drawing and data collection system, as used to create a forensic overlay and to create an industrial simulation, according to a preferred embodiment of the present invention of FIG. 1.

FIG. 9 illustrates a preferred method of use of the drawing and data collection system, according to a preferred embodiment of the present invention of FIG. 1.

### DETAILED DESCRIPTION

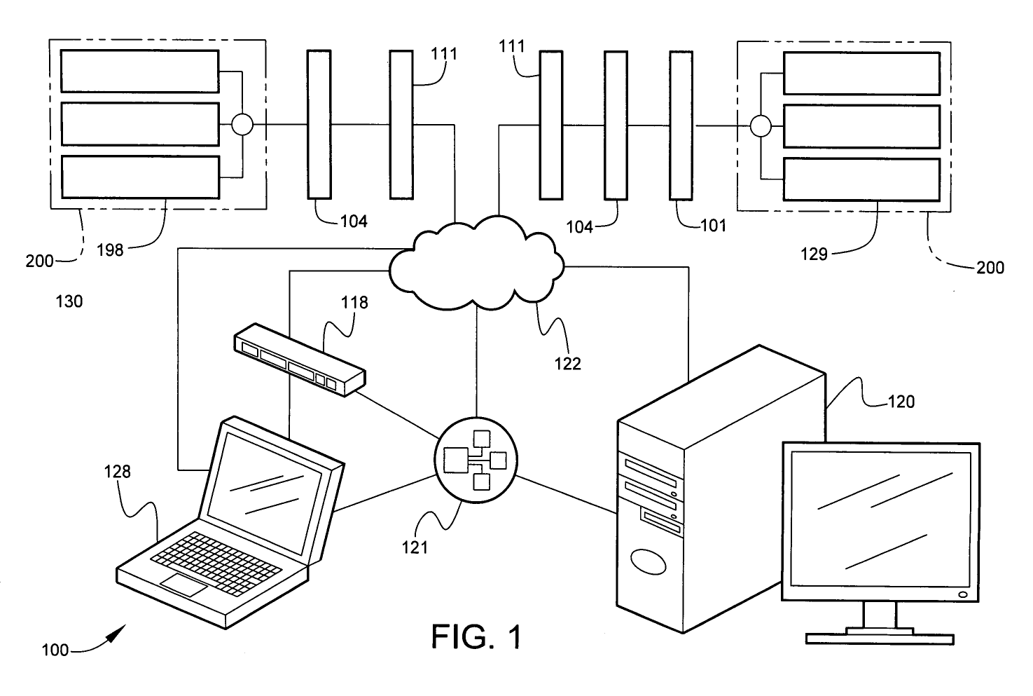

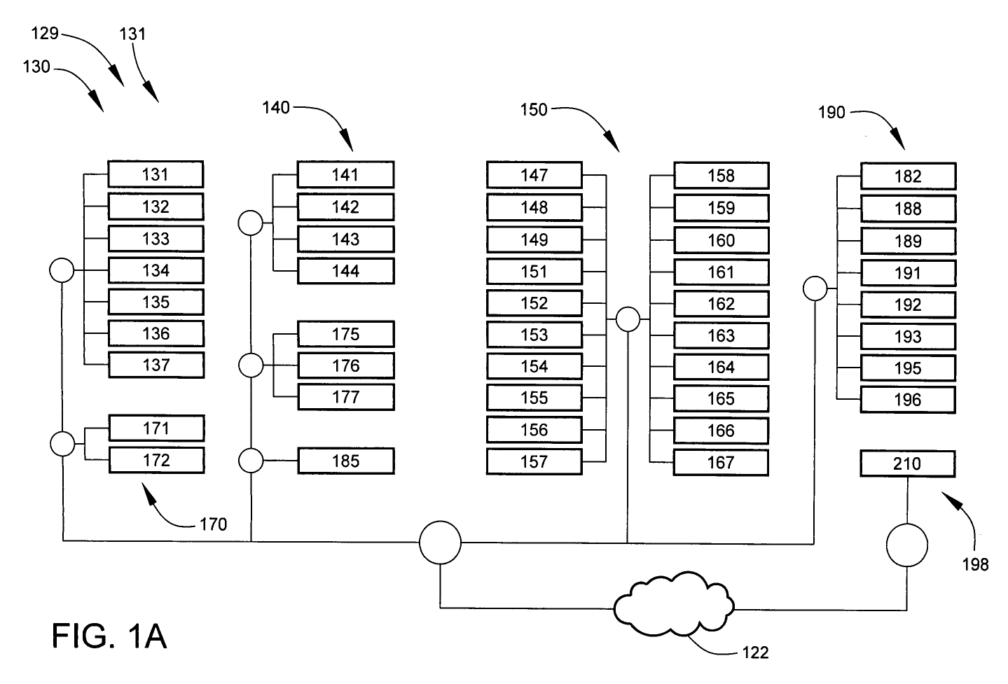

Referring now to FIGS. 1-9, showing various features and uses for drawing and data collection system 100, according to a preferred embodiment of the present invention.

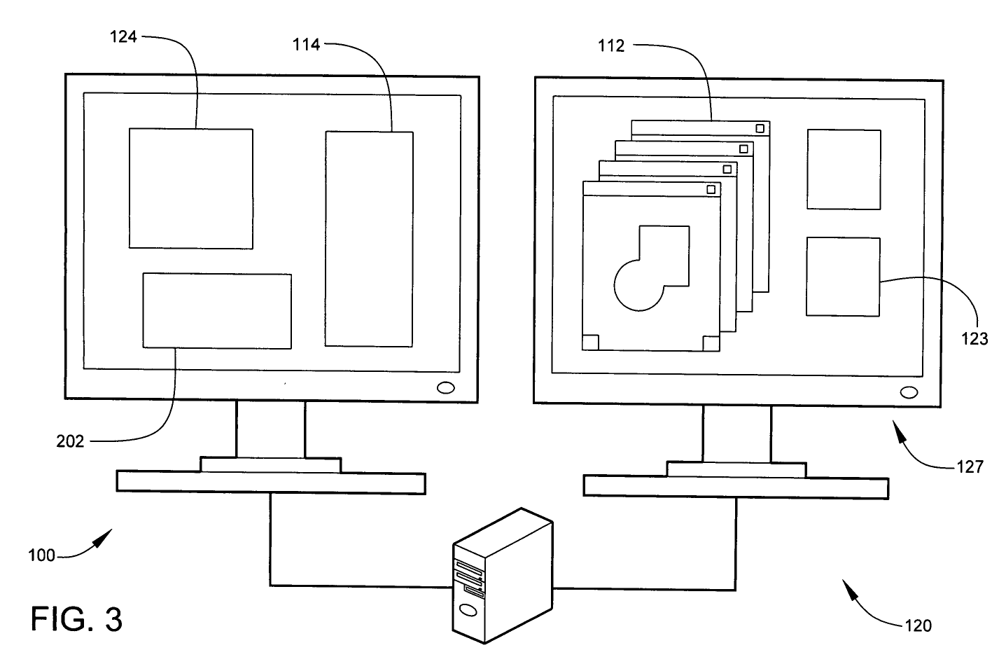

Inventors, business owners, engineers, scientists, investigators, artists and other such individuals, herein after ‘users’, desiring access to collections of drawings as a reference for drawing, will find use with the present invention presented herein entitled “Drawing and Data Collection Systems” 100. Drawing and data collection system 100 generally serves as a image retrieval and referencing system and preferred means whereby at least one user may access at least one database system 130 to be used as a resource for assisting in the creation of at least one accurate drawing 112. Drawing and data collection system 100 may further serve as a system for collecting, storing, and presenting data within at least one software program 127, as shown and discussed in FIGS. 3-5, 7 and 8.

Software program 127 is preferably run on an operating system independent platform such as Java or .NET. or other such software platform so that drawing and data collection system 100 may be either operated on Linux, Microsoft, and/or Mac systems. This feature would preferably allow programming to control user's access at certain levels for security reasons. Those with ordinary skill in the art will now appreciate that upon reading this specification and by their understanding the art of software programming as described herein, methods of use for platforms and of security arrangements will be understood by those knowledgeable in such art.

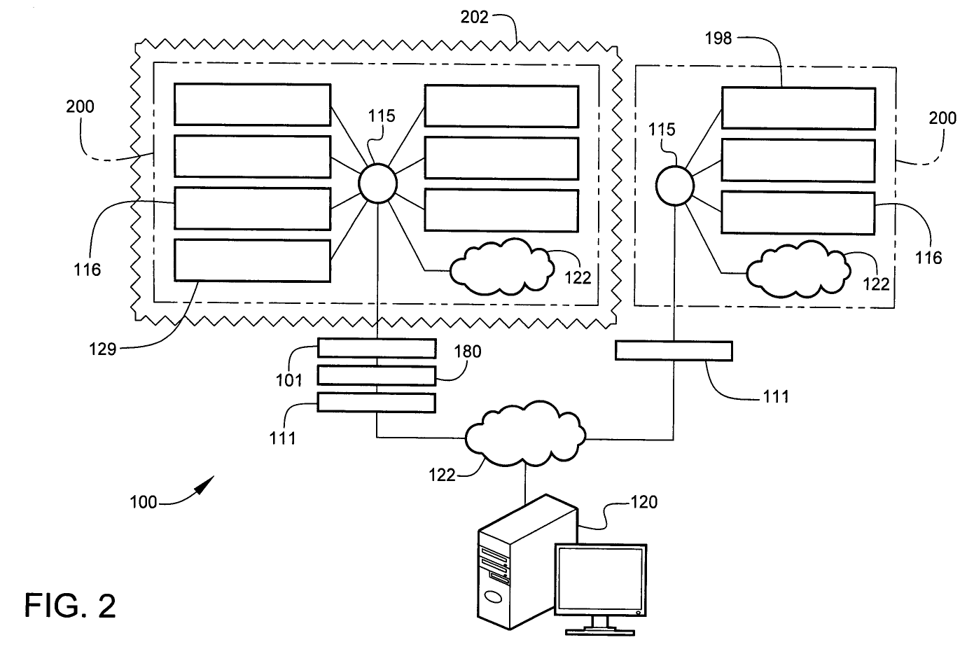

Drawing and data collection system 100 preferably comprises at least one statistical profiler 200, within a preferred embodiment of the present invention, as shown and discussed in FIGS. 1 and 2, whereby a user may effectively retrieve statistically-related, relevant information from database systems 130. Certain databases of database system 130 may be restricted by authorization 101, as deemed relevant by database entity 104 and or presiding government, to authorized users exclusively as a precautionary security measure.

Users may preferably access electronic data in drawing and data collection system 100 using computer system 120. Computer system 120 is optionally connected to at least one intranet 121 and preferably connected to internet 122, (at least herein embodying at least one internet communicator), which may be wired, wireless or by other suitable means, preferably through at least one password 111 and secured connection. Computer system 120 is optionally connected to peripherals including, but not limited to: at least one printer; at least one inputter such as a mouse, a light pen, a keyboard, or other inputting means, at least one monitor whereby user may view input data 123, output data 124 and interact with computer system 120. Monitor is preferably a ‘tablet-style’, for ‘rough’ drawing and/or note taking on-demand. This is especially convenient while designing or recording information in remote places or for note taking real-time during opportune situations using laptop 128.

Within a preferred embodiment of the present invention, computer system 120 preferably employs at least one combination of desktop computers and portable computers, laptop 128 that may be linked together to provide access to multiple users, as shown in FIG. 1. Computer system 120, for use in field service is preferably portable, such as a rugged laptop 128 or netbook with at least one docking station 118, as shown. To maintain adequate security, disk encryption functionality is preferably employed, to render the data on the laptop's 128 hard drive unreadable without at least one key and/or at least one passphrase or password 111. Preferably, each user will have at least one unique key or passphrase or password 111 that opens drawing and data collection system 100 to input data 123, but requires at least one other user to input at least one other passphrase or password 111 to withdraw information or to reach or alter critical existing files.

Computer system 120 is preferably connected via internet 122, and optionally intranet 121, or by other means of communication to database system 130 to allow data flow between various points on computer system 120. For field use, preferably a tablet style monitor incorporated into a rugged laptop 128 may be used to make rough drawings 112 and notes, offering durability and reliability in service. Laptop 128 may be wirelessly hooked as a ‘satellite’, to internet 122, to transfer data to and from computer system 120, for example to connect with the office that preferably acts as at least one base station.

Preferably, user(s) enter input data 123 such as search strings via mouse and/or in combination with keyboard and/or light pen for information targeted at image retrieval. In response to input data 123, software program 127 responds with output data 124. Output data 124 is thereafter disseminated to determine the relevance of the data being viewed by the user. Preferably, the user continues to query databases until output data 124 is satisfactory.

Drawing and data collection system 100 is preferably multi-functional to meet the needs of a host of users, being offered in a range of versions to provide access to a gammet of industry-specific images compiled in industrial drawings databases 198 and to other applications for use in investigation such as images found on investigative database 129 and for use within the legal and court system using crime definitions database 180.

The version of drawing and data collection system 100, as used to provide access to a range of industry-specific images compiled in industrial drawings databases 198 may be advantageously used in many different industrial contexts. For example, drawing and data collection system 100 may be used by those individuals in the field of Intellectual Property. At least one patent database 210 may be compiled with patent drawings 112, as related to the respective issued patents and patent applications from the various patent and trademark offices of the world, such as the USPTO, European Patent Office, CIPO and others. Preferably, the user will interact with computer system 120 by entering relevant text, search strings or by manipulating at least one mouse within software program 127 with icons or by other means intending to narrow the field of search.

The user preferably begins by entering password 111 to gain access to database entity 104 to gain authorization 101 and once authorized by appropriate means, the user preferably selects the appropriate database for viewing. Next, preferably, a search is performed by entering a set of descriptive words and/or numbers that will return a set of relevant images to choose between. User may, for example, choose to input a patent number, a specific class or subclass number, or descriptive words combined in a series for example, automobile AND car AND windshield AND driver's NEAR side, to narrow the search. Computer system 120 preferably performs an initial analysis of user input data 123 and returns as output data 124, a set of images according to the criteria entered. Next, user is preferably prompted to enter more input data 123 to help software program 127 of computer system 120 further narrowing the field of search. The user may remain active in continuing to input data 123 into software program 127 and checking images to form a final set of images. Preferably, the search input data 123 is stored with a filename that is automatically linked to ‘the searcher’, including the date, to save time when doing each subsequent search, so that the searcher and/or his or her superior has a readily accessible record of where he/she has searched and the results.

Such a search is made possible in patent drawings 112 in patent database 210 preferably, because the patent images would be compiled with descriptive tags relevant to both the patent and to drawings 112. The words present in the descriptive tag will preferably be used to help locate the desired image. Specifically, the images may be saved in patent database 210 with a set of synonyms and descriptive words linked to the image, similar to the example provided above. Those with ordinary skill in the art will now appreciate that upon reading this specification and by their understanding the art of compiling databases and creating descriptive tags as described herein, methods of compiling and relating the data compiled to means whereby the data is searchable will be understood by those knowledgeable in such art. Upon reading this specification, it should be noted that, under appropriate circumstances, when considering such issues as user, design, and marketing preferences, cost considerations, structural requirements, available materials, technological advances, etc., other data referencing and searching means may be used such as, for example, querying by use of performing rough drawings using a light pen or mouse, by using the mouse to scroll through available choices, the use of icons, hyperlinks, by using oral queries, etc., may present suitable alternatives.

Intellectual property attorneys, agents, independent inventors, drafters of patent drawings, designers and searchers may be able to efficiently locate prior art patent and trademark art for applications they are endeavoring to write and/or create drawings for. Ideally, within the preferred embodiment of the present invention, the user may ‘flip’ through output data 124 images in a tiled formation, while searching, to minimize time and effort required.

The user can preferably use the keyboard or mouse to flip through the remaining images while viewing them on the monitor of computer system 120 in a similar manner to what you would when viewing a set of pictures by hand. Those with ordinary skill in the art will now appreciate that upon reading this specification and by their understanding the art of tiling and image stacking as described herein, methods of tiling manipulation will be understood by those knowledgeable in such art. Images may also be in different orientations, depending on user-preference. It should also be noted that images will also preferably be ranked based upon statistical profiler 200 and user history/preference. Software program 127 of drawing and data collection system 100 will preferably use machine learning to determine user preferences and searching/retrieval characteristics to help optimize the process and increase software program 127 ‘user-friendliness’ over repeated uses.

As the search field is narrowed to the satisfaction of user, an option is provided within a preferred embodiment of the present invention that allows user to checkmark or select the image for later reference to speed the process. Other images can then be ‘flipped’ through to continue searching, if desired, while marking the best choices/selections for later review. A box found on the lower left side can be selected allowing user to mark the image as a potential choice. Clicking the lower right check box will preferably select the image to be immediately entered into the final image set.

Once the user selects the final image set he or she wishes to reference he or she may download the images to computer system 120 and begin to create drawings 112. The databases are preferably continuously updated with new images as individual industries develop. In one of the preferred embodiments of the invention, users may have access to the authorized libraries of their choice for a fee or pay by each download or based upon the amount of images viewed. Preferably, user(s) are allowed access to particular databases of database system 130 of drawing and data collection system 100 based upon which subscriptions they have purchased in order to download images of interest for drawing and/or investigative reference. Database entity 104 may charge fees for access or on a per-download basis. Database entity 104 may require authorization 101 from government entity for secure information. Once authorization 101 has been granted a user may be blocked from access to certain information and/or be tracked as to usage and information retrieved.

Software program 127 is preferably used to download the images to be viewed on the monitor(s) of computer system 120 independently, next to, or in combination with another drawing program. The user can search, flip through and select images in a separate window next to a drawing program, within a drawing program and/or use a plurality of monitors to select in one screen while drawing in the other. The selected images will be able to be ‘flipped’ between for ease of including many elements, even from different images, within a final single drawing 112. Items may even be able to be tiled one on top of each other as transparencies in layers to combine various aspects of each drawing 112, one with another. Once the ideal image(s) are found using the search methods, user may choose to keep the image orientated side by side with a computer drawing program for easy reference or import the image into the program to be viewed as a background, and a new picture drawn over top of the old. In this way downloaded images may be used to create drawing 112 to fit the mental image of a user.

The drawings presented and available within each library will preferably be industry-specific, for example civil engineering drawings will be in a different database than mechanical engineering drawings. Ideally, this will help to satisfy the needs of users by having an industry standard format. For example, in creating a patent application, issued patent drawings are already within the accepted parameters of the patent office's standards, thereby increasing the chances a layman's drawing 112 will be drawn in the proper format. This close adherence to industry standards will most likely be realized across the many industries that make use of the present invention.

At least one help section 114 will preferably be available to aid a user with industry-specific tips for drawing as well as a completed sample reference drawing 112 created in the accepted format. Tutorials and instructions/rules are also preferably provided within a preferred embodiment of the present invention. A set of icons for use as search or drawing tools may be included within software program 127 that allow the user to perform operations such as adding appropriate leader lines, any text, markers for aid in keeping the drawing within predefined margins. Generic or customizable flowcharts and industry-approved symbols may be provided in taskbars or within or by other selectable means, all following applicable and accepted drawing standards specific to the industry. A help desk may also be provided by database entity 104 to assist users with any unanswered questions.

Software program 127 of drawing and data collection system 100, as mentioned above, may be an independent program or may use an existing drawing program. When using an existing computer aided design and drafting program, drawings 112 may be imported into the program as a background to be manipulated, or outlined in a tracing fashion. As mentioned, another option is to have software program 127 as an independent computer aided design and drafting program, specially formatted to draw industry-specific drawings with the readily available reference. An object of the present invention is to logically compile ranked collections of related template drawings 112, which are searchable and can be narrowed to find relevant drawings 112 that are accessible as a reference for user, such as an artist. In this way, an artist may easily create a collage or effectively search for examples of eg. various poses of horses, then upon choosing one, search for pictures of riders and then backgrounds and so forth. The present invention may be used in combination with such graphics editing programs as Photoshop to bitmap and image manipulate drawing 112 to meet user preference.

The images used within the present invention may be printed material on paper, on overhead transparencies, for certain situations where use of electronic data is not convenient or preferably as an electronic version accessible by computer system 120. Electronic images can be saved on computer media/software or be stored on and available for download off a database from database system 130 to a user's computer system 120. Certain images may only be available for viewing, depending on the security-sensitiveness of the document.

The present invention is specifically designed in part to allow a user ease in searching for images, to aid in the drawing process, more particularly in the preparing of industry-specific complex drawings 112 such as patent drawings for patent applications, trademark renditions, various engineering, design and drafting applications, industrial drawings, parts, cataloging, graphic arts, and for use with investigation as discussed below. Upon reading this specification, it should be noted that, under appropriate circumstances, when considering such issues as user, design, and marketing preferences, cost considerations, structural requirements, available materials, technological advances, etc., other applications and arrangements in various industries and technologies such as, for example, mechanical engineering design and drafting, civil engineering applications such as land and utility location drawings, land development, electrical engineering, aeronautical and aerospace engineering, welding engineering, power engineering, design and simulation, for use with sign makers, graphic artists, furniture designers and builders, etc., may present a suitable alternative. It should be noted that any drawings and/or images may be copyrighted and to be legally used must be with the permission of the original artist or controlling entity. The user should refrain from making exact duplications since the object and spirit of the present invention is to make available relevant references in order to create original work based on the user's needs and wants for their intended purpose.

Database system 130 of drawing and data collection system 100, as discussed, preferably comprises industrial drawings databases 198, as shown in FIGS. 1 and 2, and further, preferably offers the option to be linked with linker 115 to information with investigative database 129, as shown in FIG. 1A, accessed through database entity 104 that may be used in investigation, crime fighting and anti-terrorism. While industrial drawings databases 198 will be available to the public at large, investigative database(s) 129 will be available to only authorized personnel in the interest of preserving security. Preferably, there will be levels of tier security within the present system accessible on a need to know basis.

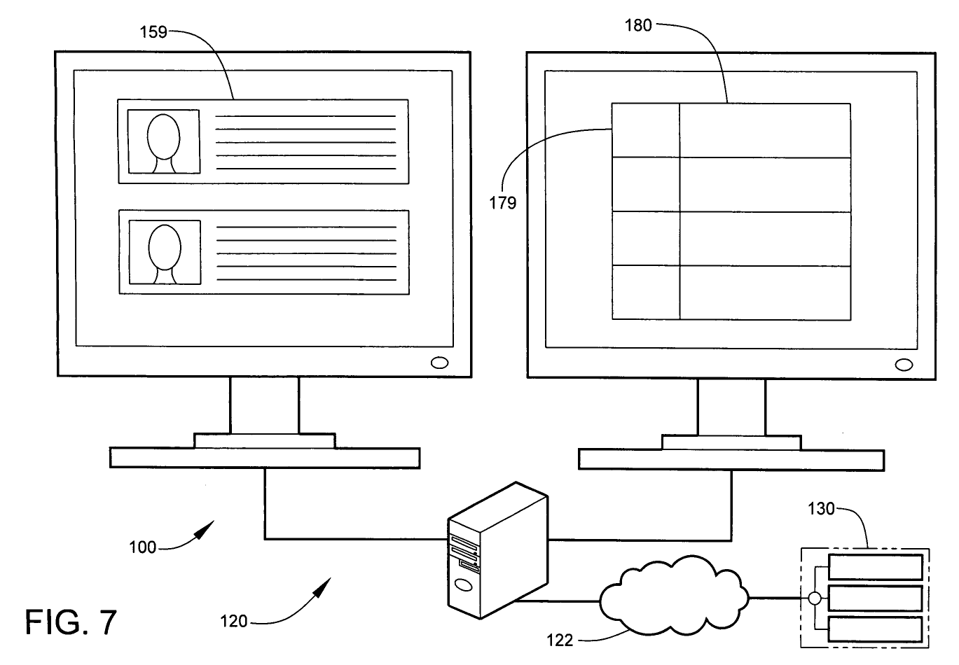

A significant application for the present invention to be used in, involves the collection and efficient amalgamation of the large amount of data from various sources that goes into investigations, especially police investigations. As previously mentioned, there is a distinct bottle neck of information that relates to a crime that may or may not be available to persons working on the case or other cases that may be related. Ideally the information would be available to all authorized parties working at the same security level, so that crimes could be efficiently solved in a timely manner. For drawing and data collection system 100 to function effectively, a means for collecting information must be realized, access provided through authorization 101 and a standardized way to logically interpret the data used for the system to perform to potential. Drawing and data collection system 100 may also be used in whole or in part by various investigators and legal personnel, such as fire investigators, prosecuting and defense attorneys, insurance investigators and others, as subsequently shown in FIG. 7.

Investigative database 129 of drawing and data collection system 100 preferably employs a similar method of use, to industrial drawings database 198, but may comprise different databases from which information may be pulled. Investigative database 129 as preferably used for crime fighting and anti-terrorism information databases preferably comprises authorized access to the following: print/impression databases 131; footprint database 132; bite-mark/odontology database 133; fingerprint database 134; tool-mark database 135; tire-tread database 136; forensic document examination database 137; weapon databases 140; gun registry database 141; ballistics database 142; gunpowder residue information/results 143; knife and hand tool database 144; social security number database 147; terrorist activities database 148; criminal history database 149; individual information databases 150; photograph database 151; suspect database 152; family tree database 153; phone/utility record information 154; voice signature database 155; economic activity database 156; crime family/gang database 157; life insurance policy database 158; statement 159; driver's license database 160; DNA profile database 161; tattoo database 162; hospital records 163; passport/immigration database 164; missing persons database 165; street names database 166; sex-offender database 167; vehicle information databases 170; vehicle specifications database 171; traffic ticket database 172; forensic anthropology/medical examiner database 175; forensic archaeology database 176; forensic psychology database 177; crime definitions database 180; timeline 181; physics/mathematical formula database 182; chemical database 185; electronic/computer evidence database 188; location information databases 190; geographical map overlay 189; topographical overlay 191; distance overlay 192; GPS locator 193; virtual globe-map-geographic information program 194; crime-scene photos 195; crime scene video 196; all preferably linked with linker 115 to statistical profiler 200; and observations/hunch notes 202, as shown in FIGS. 1-2. It should be noted that within the present invention various combinations of databases may be used depending on security level and user needs, subscriptions, etc. Databases access may be to existing or databases that have not yet been compiled. The above-mentioned list is not intended to be an exhaustive list, but rather to illustrate how drawing and data collection system 100 is to preferably function.

Various entities and sub-entities of law enforcement may have access to drawing and data collection system 100 and may share information and data that is statistically analyzed as preferably compared and ranked by statistical profiler 200, as discussed below. Observations/hunch notes 202 may be incorporated into input data 123 that preferably allow an ‘on the scene’ officer acting as a user to input unique descriptive words that are searchable may be analyzed by software program 127 using computer system 120. Descriptive words may be taken from a specially designed thesaurus that is preferably provided to somewhat standardize wording, but creativity in wording is also encouraged to specifically and uniquely describe accurately the crime scene. Police user may preferably use drawing and data collection system 100 to fully document and evaluate crime scene, an example of use is shown in FIG. 3.

Forensic science is often relied upon to determine guilt or innocence of parties accused of at least one crime. There are many sub-divisions of forensic science which are recognized by scientists, engineers, investigators and the legal system. Such sub-divisions may comprise: criminalistics; digital forensics; forensic anthropology; forensic archeology; forensic DNA analysis; forensic entomology; forensic geology; forensic meteorology; forensic odontology; forensic pathology; forensic psychology; forensic toxicology; and forensic document examination. Upon reading this specification, it should be noted that, under appropriate circumstances, when considering such issues as user, design, and marketing preferences, cost considerations, structural requirements, available materials, technological advances, etc., other forensics evidence examining methods and arrangements such as, for example, demonstrative evidence, ballistic fingerprinting, computer forensics, diplomatics (forensic paleography), forensic animation, forensic anthropology, forensic chemistry, forensic engineering, forensic materials engineering, forensic polymer engineering, forensic identification, forensic accounting, forensic facial reconstruction, forensic psychology, questioned document examination, retrospective diagnosis, skid mark, trace evidence, forensic profiling, etc., may find use with the present invention described herein.

Criminalistics is the application of various sciences to answer questions relating to examination and comparison of trace evidence, impression evidence, biological evidence, such as fingerprints, footwear impressions, and tire tracks, controlled substances, ballistics, firearm and toolmark examination, and other such evidence in criminal investigations. Within the present invention such evidence documentation will preferably be stored for access in print/impression database 131, weapon database 140, and other databases within database system 130. Crime labs may be preferably used to examine and physically store such physical evidence so evidence is not comprised by environmental elements. Police secured evidence storage warehouses preferably store physical evidence as well. Drawing and data collection system 100 preferably stores the electronic evidence and tracking means whereby physical evidence may be easily located. The physical specimens and evidence is preferably entered using barcodes or other tracking means into database system 130 to ensure the chain of evidence collection and storage can be tracked. Digital signatures or other means may be used to track responsible parties as evidence is collected and analyzed to be used later during legal proceedings.

Digital forensics is the application of proven scientific methods and techniques in order to recover data from electronic/digital media. Digital forensics specialists preferably work in the field as well as in the lab. Within the present invention, electronic/computer evidence database 188 preferably stores information and evidence collected from suspect's computers and other digital and non-digital sources.

Forensic anthropology is the application of the science of physical anthropology and human osteology, the study of the human skeleton, most often used in criminal cases where the victim's remains are more or less skeletonized. A forensic anthropologist may also assist in the identification of deceased individuals whose remains may be burned, decomposed, mutilated or are otherwise rendered unrecognizable. Techniques used by forensic anthropologists can be used to assess age, stature, sex, ancestry, and analyze disease and trauma in the victim. Forensic anthropologists may preferably work in conjunction with forensic pathologists, odontologists, and homicide investigators to identify a decedent, discover evidence of trauma, and determine the postmortem interval. Opinions developed may be preferably taken into consideration by the medical examiner. Such evidence and information may be stored in forensic anthropology/medical examiner database 175. Autopsy diagrams and pictures may also be kept as references within forensic anthropology/medical examiner database 175.

Forensic archaeology is the application of a combination of archaeological techniques and forensic science, in law enforcement. Forensic archaeologists may be employed by law enforcement to help locate evidence at crime scenes using the skills typically used on archaeological dig sites. Forensic archaeologists may locate, excavate and record buried remains. The variety of such target tasks is large and each case is unique in its requirements, thus the need to preferably use an experienced professional forensic archaeologist. Forensic archaeologists may be asked to investigate and retrieve: buried small items or personal effects from a victim of crime, which may be used to corroborate statement(s) 159 or contain other evidential value. This may include evidence buried by a perpetrator of a crime in order to hide their involvement, for example weapons, money, mobile phones, etc.; potential gravesites to locate and recover any human remains while recording all evidence in association with the remains in order to reconstruct events that took place prior to the burial of the victim(s); surface body disposals where a recent victim has been concealed under tree branches, fallen walls, rubbish, etc. Archaeological stratigraphic recordings may be used to the remove layers of material concealing the victim. Methods that may be employed include geophysical prospection, aerial photography, satellite imagery, and surveying, all which can be input into location information databases 190 and crime-scene photos 195 and preferably mapped by GPS locator 193. The collaboration of a forensic archaeologist, entomologist and forensic botanist in cases of this sort can allow very detailed reconstructions of the timing of the disposal and have in previous cases been decisive in proving a death was not accidental but a motivated, intentional criminal act. Such evidence may be preferably compiled on forensic archaeology database 176.

Forensic DNA analysis takes advantage of the uniqueness of an individual's DNA to answer forensic questions such as determining paternity/maternity or placing a suspect at a crime scene. Although the vast majority of human DNA sequences are common in humans, DNA profiling makes use of highly variable repeat sequences, called variable number tandem repeats, “VNTR”. These loci are highly similar between very closely related humans, but variable enough so that it is extremely unlikely for unrelated humans to have the same alleles.

DNA profiling commences with the extraction of an individual's DNA, typically called a ‘reference sample’. Presently, the most desirable method of collecting a reference sample is the use of a buccal swab, as this reduces the possibility of contamination. When this is not available, because a court order may be needed and not obtainable, other methods may need to be used to collect a sample of blood, saliva, semen, or other appropriate fluid or tissue from personal items such as toothbrushes, razors, hairbrushes, etc or from stored samples in banked sperm or biopsy tissue. Samples may also be obtained from biological relatives to provide an indication of an individual's profile, as could human remains which preferably had been previously profiled. A reference sample is then preferably analyzed to create the individual's DNA profile using one of a number of techniques. The DNA profile is then compared against at least one other sample to determine whether there is a genetic match.

Animal DNA may also be used to help determine location of crime, for example a dog hair found on a dead person's clothing may link the dead person to a certain location as evidenced by the dog hair. DNA is very useful in proving cases of rape and other crimes. Upon reading this specification, it should be noted that, under appropriate circumstances, when considering such issues as user, design, and marketing preferences, cost considerations, structural requirements, available materials, technological advances, etc., other DNA profiling and evidence collection such as, for example, polymerase chain reaction (PCR) technique, short tandem repeats (STR) including capillary electrophoresis (CE) and gel electrophoresis, Amplified fragment length polymorphism, Y-chromosome analysis (Y-STR), and other future tests devised to extract and analyze DNA, etc., may present a suitable alternative. Such information may be stored on DNA profile database 161 or accessed by authorization 101 on the National DNA database, or Combined DNA Index System. Such information is regulated, supervised and controlled by the United States government in the United States according to the U.S. Patriot Act.

Forensic entomology deals with the examination of insects in, on, and around human remains to assist in determination of time or location of death. It is also possible to determine if the body was moved after death, which may be important to determining the location of the initial crime scene. Forensic entomology may also be used to detect drugs and poisons, to help determine the location of an incident, the length of a period of neglect in the elderly or children and the presence and time of the infliction of wounds. Forensic entomology evidence documentation may be also stored on forensic anthropology/medical examiner database 175.

Forensic geology deals with trace evidence in the form of soils, minerals and petroleums and evidence documentation may be also stored on forensic anthropology/medical examiner database 175 and in chemical database 185.

Forensic interviewing is a method of communicating designed to elicit information and evidence and the results may be stored in statements 159 and observations/hunch notes 202.

Forensic meteorology is a site specific analysis of past weather conditions for a point of loss which may include documented evidence by acquiring local weather reports, radar and satellite images, and eyewitness accounts that may also be stored in statements 159 and location information database 190.

Forensic odontology is the study of the uniqueness of dentition, the study of teeth and documentation evidence is preferably stored on bite-mark/odontology database 133 and is discussed in more detail below.

Forensic pathology is a field in which the principles of medicine and pathology are applied to determine a cause and manner of death or injury. The pathologic process, injury, or disease that directly results in or initiates a series of events which lead to a person's death, such as exsanguination due to a stab wound, a bullet wound to the head, manual or ligature strangulation, myocardial infarction due to coronary artery disease, and other causes that may show evidence as to the cause of death or injury. The ‘manner of death’, the circumstances surrounding the cause of death, which in most jurisdictions include: homicide, accidental, natural, suicide and undetermined. This collected documented evidence may be preferably stored on the forensic anthropology/medical examiner database 175 or alternately preferably, on weapon database 140 as it relates to the weapon used.

Forensic psychology is the study of the mind of an individual, using forensic methods. Usually this science is used to help determine the circumstances behind a criminal's behavior. As a result, statistical profiler 200 will preferably be weighted reasonably heavily in creating profiles, based on forensic psychology. As well, a forensic psychologist is frequently appointed by the court to assess a defendant's competency to stand trial. The court also frequently appoints a forensic psychologist to assess the state of mind of the defendant at the time of the offense. This may be referred to as an evaluation of the defendant's sanity or insanity, which relates to criminal responsibility, at the time of the offense. This information is preferably input from appropriate medical personnel and is preferably stored on forensic psychology database 177. Forensic psychology database 177 is preferably available to attorneys from the prosecution and defense, to the jury and potentially to law-enforcement.

Forensic psychologists may also provide sentencing recommendations, treatment recommendations, and any other information the judge requests, such as information regarding mitigating factors, assessment of future risk, and evaluation of witness credibility. Forensic psychology also involves training and evaluating police or other law enforcement personal, providing law enforcement with criminal profiles and in other ways working with police departments. Forensic psychologists may also help with jury selection.

Forensic toxicology is the study of the effect of drugs and poisons on/in the human body preferably using analytical chemistry, pharmacology and clinical chemistry to aid medicolegal investigation of death, poisoning, and drug use. At least one forensic toxicologist must consider the context of an investigation, in particular any physical symptoms recorded, and any evidence collected at a crime scene that may narrow the search, such as pill bottles, powders, trace residue, and any available chemicals. These findings may be added to observations/hunch notes 202. Preferably, provided with this information and samples with which to work, the forensic toxicologist may determine which toxic substances are present, in what concentrations, and the probable effect of those chemicals on the victim. As well, determining the substance ingested may be complicated by the body's natural processes as chemical often changes from its original form once in the body. For example: heroin is almost immediately metabolized into another substance and further to morphine, thereby making at least one detailed investigation into factors such as injection mark(s) and chemical purity necessary to confirm an accurate diagnosis.

Records of injection marks and their locations may be preferably documented on a diagram of a body and any documentation stored on forensic anthropology/medical examiner database 175. The substance may also have been diluted by its dispersal through the body. Evidence taken may include samples taken from the blood, urine, hair, oral fluids and other such materials. Gas chromatography, detection of metals, and non-volatile organic substances may be used to detect and analyze these fluids. Such documented evidence may be stored on chemical database 185.

Forensic document examination may preferably answer questions about a disputed document in the case evidence using a variety of scientific processes and methods. Many examinations involve a comparison of the questioned document, or components of the document, to a set of known standards. Handwriting, for example, may be questioned as to who is the actual author. Examinations may involve: handwriting including cursive and/or printing, and signatures; typewriters, photocopiers, laser printers, ink-jet printers, fax machines; check writers, label makers, rubber stamps, price markers; printing processes; ink, pencil, paper; alterations, additions, erasures, obliterations; indentations; sequence of strokes; and physical matching. The documented evidence from forensic document examination may be preferably stored on forensic document examination database 137. Attorneys may use such evidence in cases of fraud and misrepresentation in crime definitions database 180 and be able to show the court the differences for example in signatures by using the layering transparency option of the present invention.

The following databases are listed and discussed and it should be noted that this is not an exhaustive list and that drawing and data collection system 100 may be used to collect other documented evidence and not be limited by the examples discussed herein. It should also be considered that such databases will preferably be continually be updated to keep pace with scientific discoveries, developments, legal interests, software developments and other dynamic information sources and basis.

Print/impression database 131 may be preferably compiled with various impressions that may be left at the scene of a crime. These may preferably include, footprint database 132, bite-mark/odontology database 133, fingerprint database 134, and tool-mark database 135, tire-tread database 136, forensic document examination database 137 and others. Upon reading this specification, it should be noted that, under appropriate circumstances, when considering such issues as user, design, and marketing preferences, cost considerations, structural requirements, available materials, technological advances, etc., other impressions and prints such as, for example, palms, ears, eyes, toes, elbows, tracks from implements or machines, etc., may also be included.

Footprint database 132 may be preferably compiled with footwear available from various manufacturers. Other information on footprint database 132 may include tread design, cloth/material used, information relating to various foot diseases, impressions, weight of user as versus imprint, deformations such as club foot and abnormalities such as pigeon-toed, bowlegged, etc. Various types of footwear may be included such as shoes, boots, sandals, and others.

Footprints of infants, along with thumb or index finger prints of mothers, are still commonly recorded in hospitals to assist in verifying the identity of infants. Military records of flight personnel normally include bare foot inked impressions. This is done because friction ridge skin protected inside flight boots tends to survive the trauma of a plane crash and accompanying fire, if applicable, better than fingers. Even though the U.S. Armed Forces DNA Identification Laboratory (AFDIL) stores refrigerated DNA samples from all current active duty and reserve personnel, almost all casualty identifications are effected using fingerprints from military ID card records live scan fingerprints are recorded at the time such cards are issued. These examples may be also preferably included in footprint database 132. Footprint database 132 is preferably closely linked with linker 115 with fingerprint database 134 and DNA profile database 161 for analyzing by statistical profiler 200. It should be noted that linker 115 is not shown in all its preferred and possible combinations linking the databases within the present figures in order to minimize the confusion when viewing the figures, and should not be considered to be limited by the connections illustrated therein. Linking is also a weighted feature within the present invention.

Bite-mark/odontology database 133 may be preferably compiled with dental impression of bites, information on various dental conditions and abnormalities such as overbites, under bites, diseases, denture specifications and other such information. Bite-mark/odontology database 133 may be closely linked with linker 115 with DNA profile database 161 for occurrences when teeth are available to be tested for DNA.

Fingerprint database 134 preferably comprises fingerprints, thumb prints, palm prints, and other hand-related impressions of persons. A fingerprint is an impression of the friction ridges of all parts of the finger. A friction ridge is a raised portion of the epidermis on the palm or digits including fingers and toes or sole skin, consisting of one or more connected ridge units of friction ridge skin. Fingerprint identification occurs preferably when an expert computer system operating under threshold scoring rules or alternately preferably, a human expert determines that two friction ridge impressions originated from the same finger or palm or toe, sole to the exclusion of all others. Ideally, a human expert supervises the expert computer system.

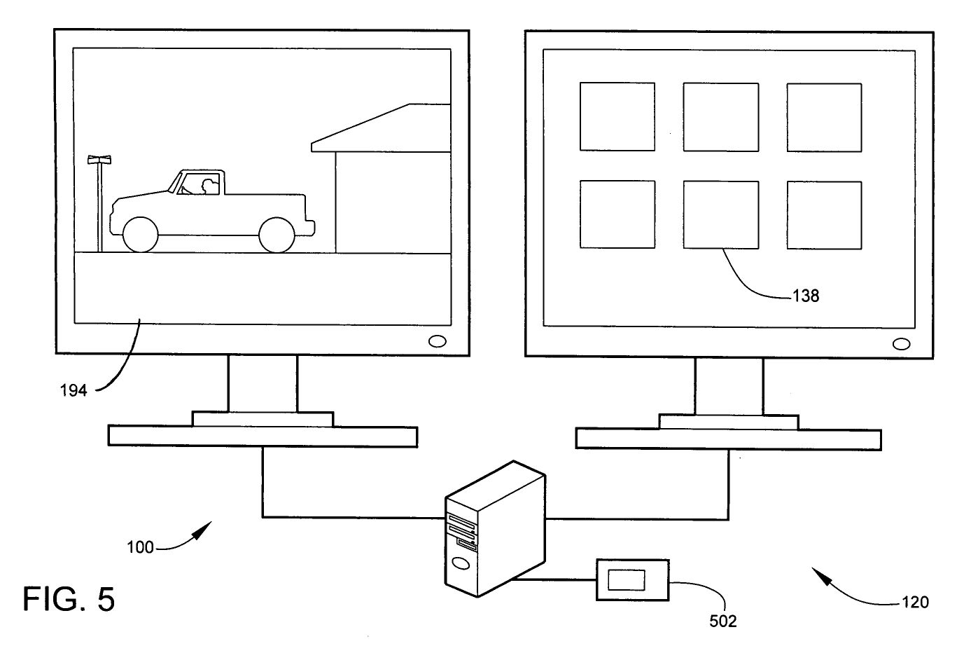

Solid-state fingerprint readers and optical fingerprint readers 502 may be used to capture latent prints, patent prints and plastic prints. Solid-state fingerprint readers and optical fingerprint readers may also be used as a fingerprint signature or authorizating means whereby access is granted to drawing and data collection system 100 and also within a preferred embodiment may be used to verify that a witness has identified a suspect out of a computerized or non-digital photo lineup 138, by pressing a thumbprint and/or signing to verify it was indeed the person identified. This is further discussed and shown in FIG. 5. Information may also be stored such as the number of fingers a person may have to aid in the elimination or non-elimination of potential suspects.

Fingerprints may be deposited in natural secretions from the eccrine glands present in friction ridge skin, secretions consisting primarily of water, or they may be made by ink or other contaminants transferred from the peaks of friction skin ridges to a relatively smooth surface such as a fingerprint card. Within a preferred embodiment of the present invention such data is collected and stored on print/impression database 131 or accessed by authorization 101 from IAFIS, JPEG 2000, or Wavelet Scalar Quantization, “WSQ”, or other international databases. Fingerprints are effective when tracking and identifying live and dead suspects and terrorists. Fingerprints are also useful in tracking in airports, harbors, border crossings and may be closely linked with linker 115 to social security number database 147, passport/immigration database 164, and photograph database 151 for use in analyzing by statistical profiler 200. This information may be linked with linker 115 to GPS locator 193 to track movement in and out of countries and over borders and to help determine patterns of behavior in suspects. Priority may also be shown to most wanted criminals such as those deemed by the CIA, FBI, DEA, or other such governmental entities.

Tool-mark database 135 may be preferably compiled with various tools, hand and power, and with sample impressions that such tools may make. Dimensions and details may also be included in the cataloging. Location of manufacture may be related to part number/lot numbers and may be helpful in determining the path through the retail chain. This particular database may also be useful to attorneys involved in Strict Product liability cases to determine fault. Suppliers of the manufactured product may be listed for reference. Serial numbers, part numbers, lot numbers may also be provided for reference and linked to economic activity database 156 if a credit card was used to purchase the item.

Weapon database 140 preferably comprises gun registry database 141; ballistics database 142; gunpowder residue information/results 143; and knife and hand tool database 144. Weapon database 140 preferably serves as a reference and record for analyzing potential weapons and their specifications, manufacturers and other such relevant information. Upon reading this specification, it should be noted that, under appropriate circumstances, when considering such issues as user, design, and marketing preferences, cost considerations, structural requirements, available materials, technological advances, etc., other weapons such as, for example, tasers, specialty weapons, bomb building equipment, etc., may also be included.

Gun registry database 141 may be preferably compiled with information including gun serial numbers, types of weapons preferably divided into classes such as single shot, semi-automatic, automatic, specifications, location(s) gun was purchased from, timing of purchases, year of the weapon, and the person who purchased weapon in question. Taser serial numbers and other such weapons may also be tracked through gun registry database 141, as mentioned above. Information on gun accessories such as scopes, clips, silencers, range of projectiles, tripods may also preferably be included.

Ballistics relates to the science of mechanics that deals with the motion, behavior, and effects of projectiles, especially bullets, gravity bombs, rockets, or other such objects using science for designing and accelerating projectiles so as to achieve desired performance. A ballistic body is a body which is free to move, behave, and be modified in appearance, contour, or texture by ambient conditions, substances, or forces, as by the pressure of gases in a gun, by rifling in a barrel, by gravity, by temperature, or by air particles. A ballistic missile is a missile only guided during the relatively brief initial powered phase of flight and its course is subsequently governed by the laws of classical mechanics. Forensic ballistics involves analysis of bullets and bullet impacts to determine the type used.

Rifling is the process of making grooves in gun barrels that imparts a spin to the bullet for increased accuracy and range. Bullets fired from rifled weapons acquire a distinct signature of grooves, scratches, and indentations which are of value for matching a fired bullet to a gun. Ballistics database 142 may be preferably compiled with information gathered from tests in internal ballistics, transition ballistics, external ballistics, and terminal ballistics as well as bullet dimensioning, composition, chemical makeup of gunpowder and metallic features of the casing. Ballistics database 142 is preferably closely linked with linker 115 with physics/mathematical formula database 182 to aid investigators in determining angles of projectiles, velocities and other physical attributes disclosed by the crime scene information. Location information databases 190 such as GPS locator 193 and virtual globe-map-geographic information program 194 may be also closely linked with linker 115 to permit investigator(s) to reenact the crime scene virtually. Theories can be also be tested against topographical overlay 191 and distance overlay 192 and checked against crime-scene photos 195 and crime scene video 196, if available.

Gunpowder residue information/results 143 may be preferably compiled with information related to gunshot primer residue taken from clothing or skin during the crime scene processing. Gunshot primer residue is expelled as tiny particles from the barrel of a firearm when it is fired. Among other materials, gunshot residue contains the heavy metals barium, lead and antimony which may be linked with linker 115 to chemical database 185. Comparative bullet-lead analysis may be performed and results checked and stored. Gunpowder burns and residue/particulate stain samples taken with the gun at increasing distances, and differing angles may also be included for reference. For this purpose a firearm with a mounted digital reading, similar to that of a radar may be used to illustrate distance, velocity, angle of bullet and other valuable information.

Knife and hand tool database 144 may be preferably compiled with any information related to knife manufacture and distribution. Knife and hand tool database 144 is preferably linked with linker 115 to tool-mark database 135. Other information such as metallurgy of various kinds of knives and tools may also be stored to be referenced.

Individual information databases 150 preferably comprise social security number database 147; terrorist activities database 148; criminal history database 149; traffic ticket database 172; photograph database 151; suspect database 152; family tree database 153; phone/utility record information 154; voice signature database 155; economic activity database 156; crime family/gang database 157; life insurance policy database 158; statements 159; driver's license database 160; DNA profile database 161; tattoo database 162; hospital records 163; passport/immigration database 164; missing persons database 165; street names database 166; and sex-offender database 167.

Individual information databases 150 may be preferably compiled with all possible physical characteristics such as age, weight, eye color, hair color, social security number, complexion, home address, and other suitable information. Mental and personality characteristics will also be preferably documented for available reference. Upon reading this specification, it should be noted that, under appropriate circumstances, when considering such issues as user, design, and marketing preferences, cost considerations, structural requirements, available materials, technological advances, etc., other individual information such as, for example, any information that may show tendencies, patterns, preferences, likes, dislikes, information for example such as what cigarettes user smokes, etc., may also be included.

Criminal history database 149 may be preferably compiled with personal criminal information of suspects convicted in criminal acts. This preferably includes fingerprints, DNA profile, age, height, weight, known affiliates, street names, gang affiliations, Criminal history database 149 may be linked with linker 115 with terrorist activities database 148, social security number database 147, photograph database 151, suspect database 152, family tree database 153, crime family/gang database 157, driver's license database 160, DNA profile database 161, tattoo database 162, passport/immigration database 164, missing persons database 165, street names database 166, vehicle information database 170, crime definitions database 180 through statistical profiler 200. Observations/hunch notes 202 are preferably linked with linker 115 to criminal history database 149 to allow comparisons to be made while narrowing the search.

An investigator may input data 123 into special notes sections and pull down menus that may be used to search to determine similarities to crimes performed by similar or same persons. For example input data 123 may be a 0.38 bullet used to kill execution style to the back of the 18 year old Caucasian, blond-haired victim's head, manual strangulation, combined with a rape, no larceny, and mayhem consisting of stab wounds after the death while tied up. By listing evidence in a series and/or parallel combination, a pattern may start to emerge as a mode of operations. This is very useful when tracking serial killers, gang activities, and terrorist activities. Keywords entered into special notes portion of observations/hunch notes 202 are compared against other keywords entered for other similar crimes to relate crimes.

Statistical profiler 200 is useful in helping to determine probabilities based on statistics and probabilities and may be used in combination with observations/hunch notes 202 in an effort to further narrow the similarities. For example, given the previous scenario input a statistical profile may show over the last 20 years 17 murders have occurred, of those murders 8 were women, 5 were below the age of 20 and that three suspects live local to the area of the murder, who have a history of killing young women. Statistical profiler 200 relates that only one has a history of Mayhem, thereby narrowing to a very likely suspect by use of historic data. Forensic psychology database 177 may also be linked with linker 115 to establish a mental profile in comparison to the crime committed.

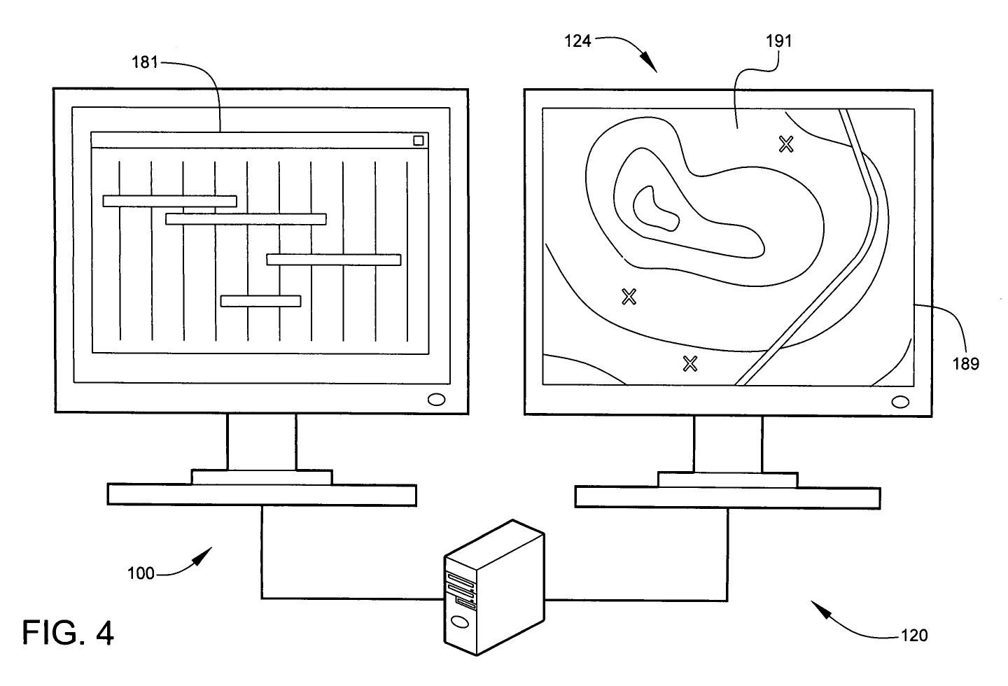

Traffic ticket database 172 may be preferably compiled with tickets issued to show patterns and possible locations of suspects when analyzed against timeline 181. Timeline 181 is shown in greater detail in FIG. 4.

Photograph database 151 may be useful for viewing photographs of individuals. Preferably, there will be photographs from a range of ages taken to allow an aging progression to be noted in instances such as cold cases or for analyzing missing persons. Further, photograph database 151 may be useful setting up at least one photo lineup 138, as shown in FIG. 5, which may be preferably created from digital or alternately preferably, analog photos. Artistic renditions or computer drawings may be used in the event of lack of photographs. These photographs may be set up with for example six similar looking potential suspects that a witness can choose between.

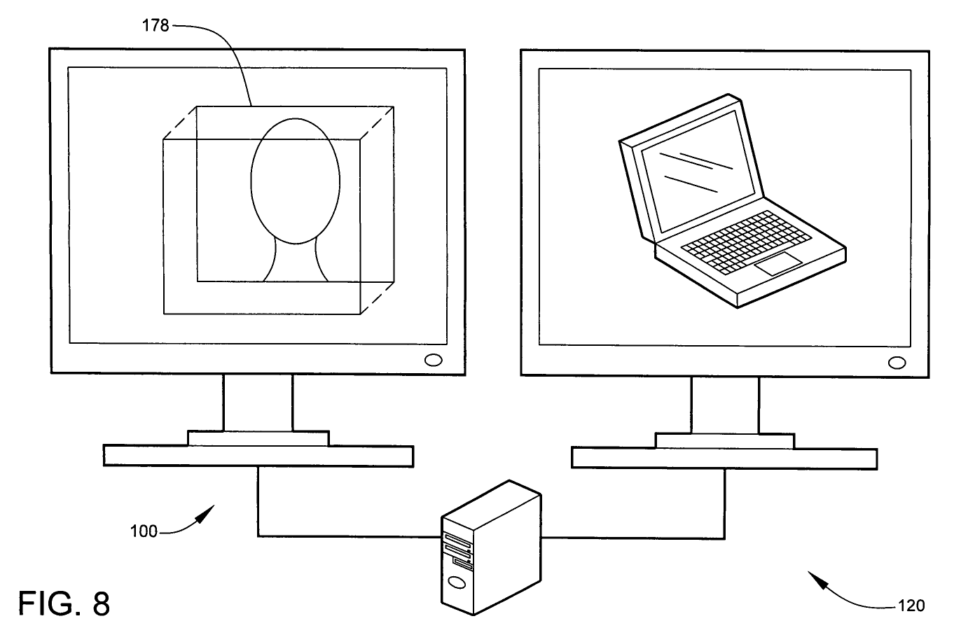

Within a preferred embodiment of the present invention the witness is able to view the line up on a computer monitor and magnify photographs to view from a distance or close up. Ideally, a witness will also be able to view suspects at different ages and possibly with different haircuts, glasses, etc as eluded to in FIG. 8. Options for tiling similar to searching are also available, as well as the option to check mark a corner for later reference. Further, an option available with the present invention is preferably optical fingerprint reader 502 that may be installed within the monitor or on a separate device (as shown) connected to digitally record the fingerprint as evidence of an individual selecting/identifying individual(s) from photo lineup 138, as shown in FIG. 5. Once the thumbprint image of the witness has been recorded, preferably a print off is made of photo lineup 138 with the fingerprint signature. As a further security measure, the witness is also preferably asked to sign his or her name to verify that the witness did in fact select the suspect chosen, as redundant evidence for trial. Photo lineup 138 of proposed suspects may be picked by investigators and/or by picked by statistical profiler 200, based on similarities in facial characteristics, complexion, height, weight, age, etc.

Suspect database 152 may be compiled by information from criminal history database 149. For example certain suspects that may have a history statistically related, but were incarcerated at the time may be substantially eliminated from suspect database 152. In this way suspect database 152 may be used to narrow the search.

Terrorist activities database 148 preferably may be compiled with suspected terrorist intelligence and only accessible to authorized government agencies. Terrorist activities database 148 preferably comprises identities and information related to known and suspected terrorists and terrorist entities. Political affiliations, military service and countries of origin, frequent travel, business connections, known passports, family relations, etc. may be included. Law enforcement and service agencies may keep on-going profiles of persons using the present invention to track terrorism. Drawing and data collection system 100 may be used by CIA, FBI and personal security teams of important political figures to run scenarios or simulations of events such as motorcades or other times when a person may be in potential danger to check for vulnerabilities. Armed forces may use drawing and data collection system 100 to create scenarios for insurgencies to rate potential for success and to fine-tune accordingly. Terrorist activities database 148 may be used to compile information related to hijackings and bombings and may be linked to industrial drawings database 198, under extreme security, to check for bomb making materials, airplane parts (that may be documented during a reconstruction process) and other such uses. Chemical database 185 may be usefully linked by linker 115 to check origins of explosive liquids, gells and other materials.

Social security number database 147 is preferably used to track individuals work patterns, age, sex and other relevant information. Social security number database 147 may be useful for economic interference torts, embezzlement and for crimes related to taxation, importing, and exporting. This may also be useful for tracking suspected terrorists that may be working or doing business within the United States or other countries. Social security number database 147 is preferably linked with linker 115 to economic activity database 156, passport/immigration database 164 and to terrorist activities database 148.

Family tree database 153 may be preferably compiled with information relating to relations between individuals. This database information may be useful when, for example investigating a possible voluntary manslaughter that may have been perpetrated by a husband or ex-husband. The data compiled will preferably be arranged like a traditional flowchart family tree with photographs from photograph database 151 and text to visually show relations. Family tree will preferably also include immediate family members in one view, then extended blood family may be added in using transparency layering function, then relationships that existed by marriage and divorce on another layer. Layers may be turned off and on according to user preference. Preferably, certain personal information may be included such as date of marriage, location, etc. Family tree database 153 is preferably closely linked with linker 115 with hospital records 163, social security number database 147, life insurance policy database 158, terrorist activities database 148, passport/immigration database 164 and DNA profile database 161.

Crime family/gang database 157 may be preferably compiled with tree diagrams similar to those disclosed for family tree database 153. Crime family/gang database 157 may also preferably contain information and photographs from photograph database 151 showing individuals related in a gang, hierarchies, business activities, etc. Crime family/gang database 157 is preferably closely linked with linker 115 to street names database 166 and family tree database 153, weapon database 140 and vehicle information database 170. Vehicle information database 170 may be linked with linker 115 to crime family/gang database 157 for tracking gang activity related by vehicles such as motorcycle gangs and vehicle theft gangs. Crime families may also be linked with linker 115 to passport/immigration database 164 to monitor cross border activity.

Street names database 166 may be preferably compiled with street ‘nick names’ or gang names. Street names database 166 may be linked with linker 115 to individual information database 150, photograph database 151, criminal history database 149 and to crime family/gang database 157. This is done to preferably create a relationship between the actual name and nick name to a photograph to minimize confusion for law enforcement. Sex-offender database 167 is preferably compiled with names, addresses and other contact information for persons accused of sex-related crimes. This may be linked with linker 115 to missing persons database 165 since children are often abducted, abused and killed by serial sex-offenders. Sex-offender database 167 is also preferably linked with linker 115 to forensic archaeology database 176, forensic anthropology/medical examiner database 175 and DNA profile database 161.

Phone/utility record information 154 may be preferably compiled with information with relation to telephone records from cellular and land-based telephones. Phone/utility record information 154 may be linked with linker 115 to GPS locator 193 from information derived from cellular telephone towers to determine relative location of individuals at certain times. Phone/utility record information 154 may be used to create proof of relationships and communication between individuals that may be involved or otherwise connected to a crime. Attorneys may use such evidence to bolster solicitation, conspiracy, vicarius and/or accomplice liability charges using charting option of crime definitions database 180.

Statistical profiler 200 may also help with clues as to criminals who prefer acting alone from those preferring to act in concert with others. Observations/hunch notes 202 may also aid in this analysis, for example with a crime scene entry, recording that there was two pairs of shoe prints leaving the crime scene. These relations can be deduced by searching such language clues within the text to pluralities such as tracks, as versus track (by the use of searching words ending in s, es, i, etc) or by an investigator including specific information as to a hunch specifically stating there was a plurality of perpetrators based on the fact there was two sets of tracks heading the same direction from the crime scene.

Voice signature database 155 may be preferably compiled so that witnesses may listen to a suspect talking. Voice signature database 155 can be compared against recorded messages or real time conversations. Voices from voice signature database 155 may be tested harmonically using physics/mathematical formula database 182. Voice signature database 155 is preferably linked with linker 115 to phone/utility record information 154.

Economic activity database 156 may be preferably compiled with information regarding individual and company banking records. Economic activity database 156 may be used by attorneys in prosecuting or defending economic crimes. As a result the IRS and other institutions may find use with the present invention. Cross-references may be made to check, bank/credit card activities as compared to crime dates possibly also comparing with phone records in phone/utility record information 154.

Life insurance policy database 158 may be preferably compiled with information related to buyers, sellers and beneficiaries of life insurance policies. Attorneys may access the information to show motive and potential conspiracies or fraud, which may be visually presented using charting, transparency overlaying and other available options in crime definitions database 180. A notification may be alerted to statistical profiler 200 when a pre-determined life insurance dollar value is reached or when multiple claims have been made that may be related. Life insurance policy database 158 may be linked with linker 115 to criminal history database 149 and to family tree database 153. Linker 115 may preferably link with weighted preference within the preferred embodiment of the present invention.

Statements 159 including those taken from witnesses and the accused may be analyzed against one another highlighting the similarities, preferably in different colored or font text styles (eg. Italics) so they may be easily visually compared. Statements 159 may be taken in written text or orally and stored appropriately. Statements 159 may be the best accounts by eyewitnesses taken at the time of the crime and may also provide a means to analyze those written or spoken by the accused. Statements 159 may be reviewed to determine accuracy and to see if a story has changed over time. Changes may also be visually differentiated to readily show subsequent changes over time between statements 159.

Content from oral and written statements 159 may be preferably extracted automatically using software program 127 of drawing and data collection system 100 to complete timeline 181. Oral statements 159 may be converted to text by a program such as Dragon Naturally Speaking. Investigator may also record oral notes at the crime scene as he or she walks through, to help with observations/hunch notes 202 that may be added at a later time. Preferably, observations/hunch notes 202 are taken on-scene to capture their desired essence. Statements 159, if taken orally may be compared against voice signature database 155. Statements 159 may be preferably linked with linker 115 to voice signature database 155. Optionally, drawing and data collection system 100 may be combined with lie detectors or other machines to further analyze authenticity of statements.

Driver's license database 160 may be preferably compiled with information relating to driving records of individuals, which may give clues as to location state/province/country of residence, age, sex, height, weight, vision, hair color, eye color, etc. Driver's license database 160 will preferably be linked with linker 115 as a connection to vehicle information database 170, and may be indirectly associated to vehicle specifications database 171 and to traffic ticket database 172. Cross border travel/traffic may be monitored by driver's license database 160. Driver's license database 160 will preferably be linked with linker 115 to passport/immigration database 164.

DNA profile database 161 may be preferably compiled with DNA information and be used as described above. DNA profile database 161 may be related to hospital records 163.

Tattoo database 162 may be preferably compiled with images of tattoos of known criminals and gang affiliations. Information may also be provided on tattoo parlors and coding within tattoos. Tattoo pictures are preferably related to individual name, and possibly to street name. Location of tattoo on the body is also noted. Tattoos may be drawn from tattoo database 162 and compared against suspects or bodies to help identify persons. Missing persons database 165 may be linked with linker 115 to tattoo database 162 to help in locating missing person or escaped criminals. Tattoo database 162 may be preferably linked with linker 115 to photograph database 151.

Hospital records 163 may be preferably compiled with medical and physical information of individual characteristics. Medication may be tracked to compare against forensic anthropology/medical examiner database 175 and may present clues to drug use and/or diseases and potentially clues to mental state. Hospital records 163 may be closely linked with linker 115 to forensic psychology database 177. Attorneys may use evidence contained in hospital records 163 to prove involuntary intoxication or other possible defenses such as insanity.

Passport/immigration database 164 may preferably comprise immigration and travel information for trips taken over national borders. Such a database will aid investigators in dealing with illegal immigrants, and terrorists. Passports give information as to country of origin and are preferably linked with linker 115 to any criminal record the individual may have. Citizenship status is also able to be confirmed and is preferably linked with linker 115 to social security number database 147 to track working status.

Missing persons database 165 preferably comprises photos from photograph database 151 or other such source and any related personal information that may help authorities to recognize missing persons. This is a valuable database for finding missing children and adults. A missing pets database may also find use should a trained police animal go missing. This may also be used by the public for search and recovery of animals in another embodiment.

Vehicle information databases 170 preferably comprise vehicle specifications database 171 and is preferably linked to motor vehicles registries for information on registrations, locations of residence, driver's licenses, vehicle make and model, year, color, accident history and is also linked with linker 115 to traffic ticket database 172. Vehicle information databases 170 may be preferably compiled with information and specifications as related to vehicle type, paint chip color matches, photographs of different makes and models at various angles. Upon reading this specification, it should be noted that, under appropriate circumstances, when considering such issues as user, design, and marketing preferences, cost considerations, structural requirements, available materials, technological advances, etc., other vehicle related information such as, for example, accidents individual has been involved in, dates of buying and selling vehicles, insurance claims, etc., may be included.

Vehicle specifications database 171 may preferably comprise specifications of vehicles from the manufacturers including such things as wheel base dimensions, frame length, vehicle height, factory tires used and other such data. Vehicle specifications database 171 may be linked to industrial drawings database 198. Vehicles in vehicle specifications database 171 may include cars, trucks, boats, planes and other aircraft, trailers, motorcycles, trains, spacecraft and other transportation means.

Crime definitions database 180 may be preferably compiled with state, federal, province and country laws, statutes, crime definitions, related cases that pertain to crimes entered so attorneys can reference for at least one use. Information may be entered into premade or customizable charts to evaluate strengths and weaknesses of cases, as shown in FIG. 7. Crime definitions database 180 will be preferably linked to timeline 181 wherein at least one attorney or investigator may enter and evaluate at least one timeline 181, as shown in FIG. 4, similar in appearance and function to Microsoft Project. Overlaps in timeline 181 preferably are displayed as warning notification and/or in different color or font text style, audible tone, bars or other suitable warning means to user. Many storing options and presentation formats are available for crime definitions database 180, and it should be noted that examples are provided below, however this is not considered to be limiting and the spirit of the invention lends itself to many options, preferences and methods that should be considered equivalents. Upon reading this specification, it should be noted that, under appropriate circumstances, when considering such issues as user, design, and marketing preferences, cost considerations, structural requirements, available materials, technological advances, etc., other charting and comparison means such as, for example, tables, graphs, etc., may present a suitable alternative.

Timeline 181 is preferably visually displayed to check the accuracy of crime timeline 181 and related events. Timeline 181 may be compared against location information database 190, virtual globe-map-geographic information program 194 and statements 159 taken at the crime scene and subsequent to the event. As mentioned previously, timeline 181 preferably operates in a similar manner to Microsoft Project to visually plot events on a linear timeline 181. In this manner times can be compared against other individuals claimed times and by emergency personnel response times. Discrepancies and/or similarities are preferably noted in colored text.

Physics/mathematical formula database 182 may preferably offer investigators various formulas that are termed in layman's terms to solve mathematical and/or physics related problems related to the crime. For example an investigator may have a measurement of a skidmark and the measurements that the vehicles traveled after the accident and wish to determine the velocity/speed the driver was travelling at to determine if a reckless speed was being traveled, or if the speed was reasonable under the conditions. Problems may be solved such as elastic, inelastic collisions, travel distances to calculate travel time and many others. Attorneys may also find use with this feature of the present invention.

Preferably, user chooses from a drop down box the problem he or she wishes to solve and begins entering numbers into other available spaces/text boxes in response to computer input demands. Upon reading this specification, it should be noted that, under appropriate circumstances, when considering such issues as user, design, and marketing preferences, cost considerations, structural requirements, available materials, technological advances, etc., other input means and other problems to be solved such as, for example, velocity of a bullet, angles, projectile height, force used (reasonable or not), stopping distances, using the formula database in conjunction with another database such as for example, weight of vehicles may be obtained from vehicle specifications database 171, etc., may suffice.

Chemical database 185 preferably comprises information on various chemicals, compounds, acids, bases, poisons, drugs, medicines and others that may be used to determine cause of death or injury.

Electronic/computer evidence database 188 preferably stores documentation discovered during the investigation into the contents of hard drives of computers, and other electronic evidence collected. Attorneys may use the stored evidence to show the court for example what websites a suspect may have been using and material downloaded. This may be valuable to monitoring and prosecuting terrorist activity that may be coded by checking quality, quantity and sources. Such information may be tracked by statistical profiler 200 based on the number of emails and content.

Location information databases 190 preferably comprise geographical map overlay 189; topographical overlays 191; distance overlays 192; GPS locator 193; virtual globe-map-geographic information program 194; crime-scene photos 195; and crime scene video 196.

Geographical map overlay 189 may map out the roads, cities and land locations that may be used in both industrial drawings database 198 for use in civil engineering drawings, land development etc., and in investigative databases 129 of drawing and data collection system 100. This feature may be used similar to or in combination with a web mapping service such as MapQuest or other. Preferably, user may map out different routes in different colors that may be overlaid on each other and potentially over topographical overlay 191 so all or some of the routes are visible for comparison. Preferably, accurate times for travelling between locations may be estimated.

Topographical overlay 191 may be populated with topographical contour maps of the earth's surface. These maps may be useful in determining extremely accurate distances between scenes when combined with geographical map overlay 189. For example this feature may be used to examine distance(s) between the crime scene, the suspect's house and place of work, to help determine if the trip was possible as compared to timeline 181 established. This may also be compared with known weather conditions and other natural events. Topographical overlay 191 as used in conjunction with forensic archaeology database 176 may give clues as to where a body may have naturally/unnaturally moved to over a period of time. For example, if a body was left on a hill it would be likely that it would be dragged the direction of least resistance, downhill by animals possibly into a wooded area for cover.

Distance overlay 192 may be preferably used as a means whereby different possible paths or angles may be explored similar to that of the function of geographical map overlay 189. It should be noted that the images referenced in a preferred embodiment of the present invention may be exported into the drawing portion of software program 127 that serves to show images or lines through a plurality of layers, as shown in FIG. 4. For example distance overlay 192 may be exported and placed over top of topographical overlay 191 and a potential path is drawn on the first layer, then another path on a second layer, another on a third and so on. The investigator will be able to view all of the potential paths or to eliminate/turn off various layers all still while viewing the topographical overlay 191. In this way investigator may be able to present various scenarios and eliminate others. For example, the direction and angle a victim may have been shot at may coincide with evidence collected from a particular location. An example such as this may be presented visually using charting and other options in crime definitions database 180. Distance overlay 192 may be linked with linker 115 with physics/mathematical formula database 182 for accuracy of calculations.

GPS locator 193 is preferably used to document the crime scene and any related locations of interest. GPS locator 193 is preferably linked with linker 115 to physics/mathematical formula database 182 to aid with accurate calculations since the earth is not perfectly flat which may cause slight inaccuracies in calculations of distances. Distances can be verified, angles, and topography that may affect the evidence. Upon reading this specification, it should be noted that, under appropriate circumstances, when considering such issues as user, design, and marketing preferences, cost considerations, structural requirements, available materials, technological advances, etc., other locating devices and uses such as, for example, tracking of GPS monitored house arrest ankle monitors, GPS monitoring of suspects vehicles, radar, sonar, etc., may also present useful evidence.

Virtual globe-map-geographic information program 194 such as Google Earth may be used to provide a means whereby a simulator may be ran using various scenarios as described and examples provided below. A virtual globe, map and geographic information program such as Google Earth may be used to map the earth by the superimposition of images obtained from satellite imagery, aerial photography and GIS 3-D globe. Such a program may be used within the present invention to run crime scenarios. Such a program may be used to pinpoint locations, distances, topography and possible views of a crime scene.

Crime-scene photos 195 are preferably compiled with photos from the crime scene and from other areas of interest. Photographs may comprise panoramic photos taken from a single GPS recorded position. Photographs may be still shots or video. Preferably, crime scene is recorded from various heights possibly on a height-adjustable tripod that allows camera to rotate 360 degrees. Height-adjustable tripod may be set for example six inches above ground level for at least one first set of shots, followed by a set of photographs being taken at average eye level, about 5 feet from ground level, and one set taken at a higher level as a bird's eye view. The various views may provide incite separately or in combination with other views. Distances may be entered to allow angles to be calculated by physics/mathematical formula database 182. GPS locator 193 is preferably used to enter locations of evidence in relation to photograph. Photographs and/or video may be input into programs such as QuickTime VR or within software program 127 of drawing and data collection system 100 to create simulations, panoramas, positional relationships, views around entire object so as to create models when referencing.

Photographs may also be taken from before and after the event to compare against crime-scene photos 195. Crime-scene photos 195 are preferably logically organized from the most proximate area of the crime outwards, possibly taken in radius from a central point. Photographs may also be taken to document where a crime occurred and to where it was moved to, for example if a body has been moved or other such situation.

Crime scene video 196 is preferably stored in a manner similar to crime-scene photos 195 for reference by investigators and/or attorneys and court personnel. Crime scene video 196 may be obtained from dash-mounted video cameras in police cruisers, store, bank, airport, border-crossing security camera surveillance, from private video taken documenting evidence, and other suitable sources.

Statistical profiler 200 preferably creates a weighted statistical link and filtering means between the entire information compiled within databases user is authorized to use, and input data 123 entered by user and to known web/public statistics 116 that may be searched by a search bot or crawler, as illustrated in FIG. 2. Linking is preferably preformed by linker 115, as shown in FIGS. 1, 1A and 2. This weighting is partially reflected by the linking of the various databases, as described above. Statistical profiler 200 may be disabled by user if user desires. In this situation user may be prompted at the end of the search session as to whether statistical profiler 200 may be ran to provide alternate suggestions and bring in relationships potentially not outputted. Various databases, according to the preference of user, may be temporarily disabled to eliminate the input of information from those specific databases into the analysis of statistical profiler 200. Statistical profiler 200 preferably includes many options such as the ability to turn off and on various databases, various security levels, various settings to allow a user to limit another user's access to input data 123 and output data 124. For example a user may be only given access to input information and only into certain databases. Another user may be given access to only output information and only from certain databases.

Preferably, based upon input data 123 entered by user, database(s) is/are searched. Statistical profiler 200 preferably includes a help section 114 to properly assist efficient and effective use and query by user. Other options in statistical profiler 200 may allow different weightings to be set for observations/hunch notes 202 and others, for example a seasoned investigator may put a higher weighting to his or her observations/hunch notes 202 than a less experienced person. Another example may be, during a bank robbery an individual is hit and killed as the criminals flee the scene, therefore user may opt to turn off sex-offender database 167 and chemical database 185 and use vehicle information database 170, physics/mathematical formula database 182 and economic activity database 156 for instance. This serves to speed up the search by eliminating un-related low probabilities, based on human instinct.

Various charting options are available to be manipulated according to user preferences and to application. These may be preferably tracked by machine learning. Options are available to allow multiple users to view, or to allow different levels of access to different users. Upon reading this specification, it should be noted that, under appropriate circumstances, when considering such issues as user, design, and marketing preferences, cost considerations, structural requirements, available materials, technological advances, etc., other options, preferences such as, for example, different security options such as when laptop is removed from docking station 118 access is limited or increased, users can preferably choose which state/country for applicable laws to populate charts for use by attorney, the ability to move between screens or windows for example to show portions of video segments, then refer to text from statements, then refer to fingerprints, then to a GPS reading to show where the fingerprints are located in relation to the crime, thereby providing a means for an attorney to review and/or present a case, the system can also have a slideshow presentation option for this purpose, etc., may present a suitable alternatives and uses.

Statistical profiler 200 is preferably highly influenced by psychological profiling of crimes and persons. Statistically-based trait and tendency information collected based on confessions of serial killers, terrorists former gang members and data collected from criminals over time have helped to develop profiles of what type of persons have committed and are likely to commit certain crimes. For example, if a crime such as the kidnapping and murder of several young African-American school-age boys is perpetrated during daylight hours in a predominately African-American neighborhood certain assumptions may be made as a starting point for the investigation. Such assumptions based on probability may include, that in order to reoffend within the same predominately African-American neighborhood, the perpetrator must be substantially inconspicuous and be able to freely travel/blend in with the people located there, so will most likely be an individual from the area, know the customs, safe entries and exits, when the children are supervised as versus when not and according to the other facts of the crime may be a college graduate or uneducated, may be in a certain age range, within a certain income bracket at a type of job, with a certain history of crimes like sex offenses and/or cruelty to or killing animals, etc. Statistical profiler 200 will preferably be programmed based on the advice of an experienced criminal profiler.

Drawing and data collection system 100 using statistical profiler 200 will preferably be able to link and organize similar crimes together to be able to quickly check similarities to see if it may be the same criminal or closely related. Organization within statistical profiler 200 can occur by type of crime, age of victim, location of crime scene, year, and other specific choices. Statistical profiler 200 may also be used as a search bot to analyze news publishings, utility hook-ups and other means whereby information is provided that is of public record using web/public statistics 116. Statistical profiler 200 has many options and the examples and information provided are to show its use and are not meant to limit the scope of its novelty or equivalent uses.

Observations/hunch notes 202 are preferably entered by a user to make use of human perceptive abilities that can help direct the clues in the case. And the course of the investigation. Many times computer systems 120 are limited because of the lack of real time cognitive perception. Software program 127 seeks to provide a means whereby this functionality can be incorporated into the present invention.

Observations/hunch notes 202 are preferably input by the investigator user at the crime scene to substantially ensure that the ‘feel’ of the crime scene is accurately documented in an attempt to rely on conscious and subconscious perceptive thoughts surfacing in the input data 123. Crime flow may be more closely analyzed using observations/hunch notes 202. An example may be that a responding investigator to a murder scene notes that there appears to have been a burglary however he or she may note that nothing of value appears to be taken, thereby shifting the focus of the investigation from burglary to another possible alternative. This is especially valuable for when cases are handed off to different investigators or over a substantial amount of time on cold cases. Similar to the functionality of comparing statements, statistical profiler 200 and/of software program 127 may compare and display visual similarities by comparing against other similar cases and inputs from different users. Upon reading this specification, it should be noted that, under appropriate circumstances, when considering such issues as user, design, and marketing preferences, cost considerations, structural requirements, available materials, technological advances, etc., other crime documenting means and comparison such as, for example, similar GPS locator hits to exact locations of different crime scenes, comparisons made between oral statements, comparing photographs by body mayhem, etc., may present a suitable alternatives and uses.

The following are some examples to show capabilities and how drawing and data collection system 100 may be used. The following examples are provided to illustrate the versatility and uses of software program 127 and is by no means meant to be a comprehensive or limiting list.

Examples of use for investigators for recreating the crime virtually: Police detectives may use images collected from suspect database 152 and vehicle specifications database 171 to assemble an image showing a truck, like the suspect normally drives according to registration records (same color, model, year, etc) with a style of canopy seen leaving a crime with a suspect placed in driver's seat, as shown in FIG. 5, on the angle from which the witness claims to have seen. The investigator may place the truck on the appropriate street backdrop using virtual globe-map-geographic information program 194 and set the speed of the vehicle using timeline 181 and calculations derived from physics/mathematical formula database 182 all according to GPS locator 193. Different suspect's images can be inserted, different vehicles, different streets to test reliability of witness' statement 159. Trip can be set to run on distance overlay 192 layered on topographical overlay 191, as shown in FIG. 4. Various scenarios may be run like this while viewing statement 159 on another monitor, as shown in FIG. 3.

In this way drawing and data collection system 100 may be used as a simulator. In the same spirit a gear designer, an industrial designer, a projectile developer and others can virtually test and refine his or her design, as eluded to in FIG. 8. A land developer can take a civil engineering drawing of the proposed development and build a mockup community inserting different home styles against a backdrop and deciding which trees to keep, which to remove, and using topographical overlay 191 to help decide where to build and drain a man-made lake, etc. A further example may be that a furniture designer may wish to add to his product lineup and may download catalog images of his competition's products to view what is currently being made and what isn't, thereby being able to analyze and design/engineer around a competitor's products.

Examples of use for investigators for recreating the crime virtually: Composite sketches may be overlaid upon photos of suspects like a transparency to assess similarities, as shown in FIG. 8. Overlays for forensic face-matching 178 may be used on dead persons as well as masked persons caught on video tape to compare against computer models or for age enhancing/appearance altering. Forensic artists and traditional artists may be able to slightly change features for age enhancing and with different haircuts, glasses/no glasses, facial hair by using the different layers functionality. Further, art teachers may use drawing and data collection system 100 to aid in teaching.

Examples of use for investigators in recreating the crime analytically: Using probability component of statistical profiler 200 based on statistical history of criminal profiles, location and victim specs may help to pinpoint a potential profile of a criminal. For example, a male body is dumped near a crossroads of two interstates, was last seen at a truck stop . . . may be a trucker so check missing persons database 165, tire-tread database 136, vehicle specifications database 171, vehicle information database 170, toll-booth video surveillance, traffic ticket database 172, timeline 181, geographical map overlay 189, GPS locator 193, and spending habits based on credit-cards from economic activity database 156. Such an example is shown in FIG. 4.

Examples of use for investigators for creating flowcharts and timelines 181: Family trees may be linked with linker 115 together with victim using family tree database 153. For example a witness has come forth with a description of Mr. X Criminal, however upon checking suspect database 152 investigator determines Mr. X Criminal was incarcerated at the time. Investigator then opens family tree database 153 one layer at a time finding that in fact the first cousin of Mr. X Criminal was the actual perpetrator, but looked very similar and lived in the same neighborhood. The monitor may be used to compare mug shots of similar looking persons that may have been involved in the crime for witnesses to view and pick from as described supra, as shown in FIG. 5. The difference between photo lineup 138 and family or crime tree is that no relation between individuals is shown in photo lineup 138 by use of connector lines or other suitable connecting means.

Examples of use for investigators for tracking chain of custody of evidence: Software program 127 may be used to check for example bullets and a gun retrieved from a crime scene, the officer who entered the evidence, where the evidence is stored, where the bullets were test-fired, what fingerprints were retrieved off of the gun handle, who made the fingerprint analysis, where the analysis is stored, were the fingerprints checked against the victim using fingerprint database 134 or by the medical examiner on the corpse and entered into forensic anthropology/medical examiner database 175, was the gun checked against gun registry database 141, etc. Autopsy diagrams and pictures may be kept as references within the forensic anthropology/medical examiner database 175 to allow investigators to check for example, the diameter of the entry wound as a means of cross-referencing against the bullet retrieved.

Examples of use for investigators for organizing evidence: Investigators may create files using software program 127 that can be organized loosely allowing, for example a police investigator may have a list of 5 suspects he or she wishes to investigate. He or she will be able to create 5 individual profiles including statements, fingerprints, shoe size, photo, home address, tattoos, driver's license, DNA profile, handwriting samples (which can be overlaid using the transparent layer option), ballistics information and vehicle type for each of the suspects. A file of the pictures of the crime, blood spatter evidence, any DNA or shoe print evidence or other may be kept in the same file or an adjoining file to be easily compared against the suspect's files and/or statement 159. Police may keep on-going profiles of persons using the present invention to track terrorism, conspiracies and embezzlement. Matching points, events and clauses found in witness statements 159 may be used to help create probabilities and help weed out non-truths.

Private investigators may also find use with the present invention using it in much the same manner as law-enforcement, however it is presumed that private investigators will not be privy to all information for obvious security reasons.

Fire investigators, prosecuting and defense attorneys, and insurance investigators may also find use for drawing and data collection system 100 to perform various functions. Fire investigators may use their access to various databases to check the occurrence of fires in the proximity, to check the fire statistics, to check life/fire insurance plans in place, to check routes from a fire station, to confirm timing, to reenact fire scene scenario(s) with respect to the statement(s) of the individual(s) involved. Upon reading this specification, it should be noted that, under appropriate circumstances, when considering such issues as user, design, and marketing preferences, cost considerations, structural requirements, available materials, technological advances, etc., other fire investigation, insurance investigation or other investigations may also use the present system to store and verify evidence such as, for example, bomb fragmentations, accelerants, statements, etc., may present a suitable alternative and/or use.

Prosecuting and defense attorneys may use drawing and data collection system 100 to perform analysis and/or reenactments of the crime and crime scene, to create possible scenarios and to link with crime definitions database 180, to accurately chart and organize the elements 179 of the crime. For example, if a defendant was being charged with Felony Murder that occurred during the commission of a Robbery, the attorney would be able to select the state the charges are being brought against the defendant in and the specific elements 179 of the crime would be preferably listed in an outlined chart form with any pertaining statistical information available by a quick search and selection.

For example, in order for the defendant to be charged with the Felony Murder, he would need to first be guilty of the underlying robbery charge. Elements 179 of robbery for the selected state may be 1) The taking and carrying away; 2) of the property of another; 3) with the intent to permanently deprive the owner of the property; 4) taken from the presence of the victim; and 5) by use of force or threat of force. A chart like the one shown in FIG. 7 would preferably include a column with elements 179 that allows the attorney to logically order the corresponding facts from the case, motives, etc. as well as any possible defenses. Defenses may also be analyzed for relevance and be referenced against the facts and statistical information. In this manner an attorney may be able to chart various possible refutes that may be made by opposing council, allowing a structured case presentation from a variety of paths. Courtroom lawyers and others may use the program to organize evidence of available text and images for records and use before and during trial. Prior cases can be organized according to issues, holdings, relevance, date, jurisdiction, statute and other criteria. The present invention may provide a link from crime definitions database 180 to Lexis Nexis or other such searchable archive.

Statistical profiler 200 may also preferably provide at least one analysis of court decisions and related statistics to rate the probability of success of the case as entered. Upon reading this specification, it should be noted that, under appropriate circumstances, when considering such issues as user, design, and marketing preferences, cost considerations, structural requirements, available materials, technological advances, etc., other charting arrangements and contents may be used with various state/province/county/country/jurisdiction such as, for example, common law and model penal code or other applicable statutes and laws, as well as other areas of interest such as criminal procedure, or for use in civil cases, etc., may present a suitable alternatives and/or use(s).

Referring more specifically now to FIG. 1A showing a flowchart of databases in database system 130 as linked using linker 115 in drawing and data collection system 100, according to a preferred embodiment of the present invention. The relationship between database systems 130 is shown with investigative database 129 as separated but linkable to industrial drawings database 198. Not shown are the authorization 101 and other key features, but the present figure is preferably used to illustrate linker 115 as a hub that may be use to logically group and collect databases and information contained within. Many different wiring orientations are possible and database system 130 may contain more databases. However, database system 130 as shown may serve as an example to illustrate how the present invention may serve to operate. Authorization 101 may be required at various points within database system 130 and databases may be secured by different means. Industrial drawings database 198 preferably comprises more databases than patent database 210, as shown in FIGS. 1 and 2, but has been illustrated as such to show industrial drawings database's 198 relationship with investigative database 129 within database system 130 of drawing and data collection system 100 preferably using internet 122.

Referring now to FIG. 2, showing the linking of databases of drawing and data collection system 100 as used with statistical profiler 200, according to a preferred embodiment of the present invention of FIG. 1. Databases within drawing and data collection system 100 are preferably linked with linker 115 as shown, to provide access to related databases to increase search speed and focus. Passwords 111 and various security measures are used to uphold security levels. Security is also preferably provided on individual computers and components within computer system 120. Authorization 101 and database entity 104 are shown as well as a possible route to access crime definitions database 180. Crime definitions database 180 may also be linked to other archives as discussed above. Crime definitions database 180, investigative database 129 and industrial drawings database 198 are normally accessed through database entity 104 (not shown in this particular figure).

Referring now to FIG. 3, illustrating drawing and data collection system 100, as used to compare crime data, to search using statistical profiler 200, according to a preferred embodiment of the present invention of FIG. 1.

Drawing 112 are shown as references, searched and or downloaded in a tiled orientation according to the present invention, but may be manipulated or viewed in an orientation as shown in FIG. 5. Help section 114 is shown as it may be used to manipulate output data 124. Observations/hunch notes 202 may be entered as shown, reviewed or may be preferably entered by laptop 128 at crime scene as discussed previously. Input data 123 and output data 124 may be arranged to view according to user-preference using many options.

Referring now to FIG. 4, showing timeline 181 and illustrating use of certain features of location information database 190 of drawing and data collection system 100, according to a preferred embodiment of the present invention of FIG. 1. Timeline 181, in the present figure is illustrated as would be used to compare and verify/de-verify timing that may be obtained from statement(s) 159 and comparing against topographical overlay 191 and geographical map overlay 189 of location information database 190 using layering function of drawing and data collection system 100.

Referring now to FIG. 5, showing a virtual simulation of virtual globe-map-geographic information program 194 and a photo line-up of drawing and data collection system 100, according to a preferred embodiment of the present invention of FIG. 1. Virtual globe-map-geographic information program 194 may be used to run and/or reenact crime scenarios, such as placing an image of a suspect at the appropriate angles fleeing the scene in a particular vehicle, such as the truck shown. Such a program may be used to pinpoint locations, distances, topography and possible views of a crime as described in the example provided. The figure also illustrates optical fingerprint reader 502 as connected to computer system 120 for use in verifying the identification of an individual that has been identified from photo lineup 138. Optical fingerprint reader 502 may be alternatively housed in monitor screen to act as a touch screen, as discussed previously, however the option is not shown in the present figure.

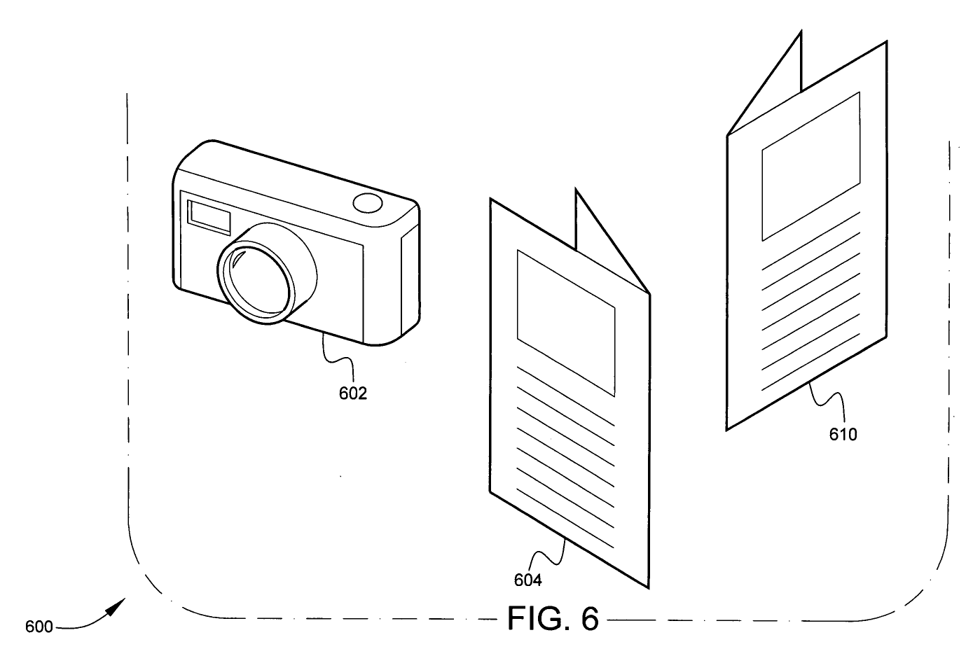

Referring now to FIG. 6 an accident investigative kit 600 for use in vehicular accidents, according to a preferred embodiment of the present invention of FIG. 1. Accident investigation kit 600 may be preferably sold as at least one kit preferably comprising the following parts: at least one digital camera 602; at least one notebook 604; and at least one set of user-instructions 610 in the preferred form of a manual. Accident investigation kit 600 preferably comprises digital camera 602, alternately preferably, disposable camera 602 may be used to photograph accident scene evidence that may be uploaded to a file. Notebook 604 is preferably provided so that notes may be documented as to what happened prior to the accident, consequent to the accident and after the accident. Notes are preferably taken at the scene when everyone has reached a point of safety.

Accident investigation kit 600 is preferably in a small enclosed kit form that may be easily stored in a vehicle for convenient use when needed. User-instructions 610 are preferably provided on a step by step basis allowing user to fill-in-the-blank to retrieve the pertinent information and to document the scene. Examples of information that may be required to be filled in will be the name of driver, insurance policy number, time, location of accident, residence, position of vehicles, and other such parameters, and is preferably very similar to a police accident report. The accident investigative kit may be used to decrease accident fraud and to reduce insurance rates for safe drivers. The information accumulated in the notebook, paper or electronic may be uploaded to the insurance company via computer system 120 and/or to vehicle information database 170.

Drawing and data collection system 100 may be preferably provided for sale in commercial versions for different industrial fields, and customized versions with access to specific files. Data collection system 100 may be marketed and/or sold as at least one professional version or as at least one standard version and offering a range of intermediate customizable optioned versions. The databases available will be dependent on the security level and will serve to provide for a wide assortment of applications. Upon reading this specification, it should be noted that, under appropriate circumstances, when considering such issues as user, design, and marketing preferences, cost considerations, structural requirements, available materials, technological advances, etc., other marketing and selling arrangements such as, for example, pay-by-click, unlimited use, payment per solved case, etc., may present suitable alternatives.

Referring now to FIG. 7 showing options of statement 159 comparing and highlighting discrepancies and using options within crime definitions database 180 to organize, prepare and present a case using drawing and data collection system 100, according to a preferred embodiment of the present invention of FIG. 1. Statement(s) 159 may be analyzed and compared, as shown and related to elements 179 in crime definitions database 180. Crime definitions database 180 as discussed may be linked to archives, preferably through internet 122 and may serve for presentation purposes and analyzed against former cases. Scenarios may also be created based upon the information included. Web/public statistics 116 may be also accessed. Crime definitions database 180 may or may not be within database system 130

Referring now to FIG. 8 illustrating drawing and data collection system 100, as used to create forensic overlay 178 and to create an industrial simulation, according to a preferred embodiment of the present invention of FIG. 1. Forensic overlay 178 is shown using layering function and not shown on the proximate layer could be additions of facial hair images, glasses or other possible disguises. Age enhancing and comparisons to corpses and masked individuals may be made using this function as disclosed within the present invention.

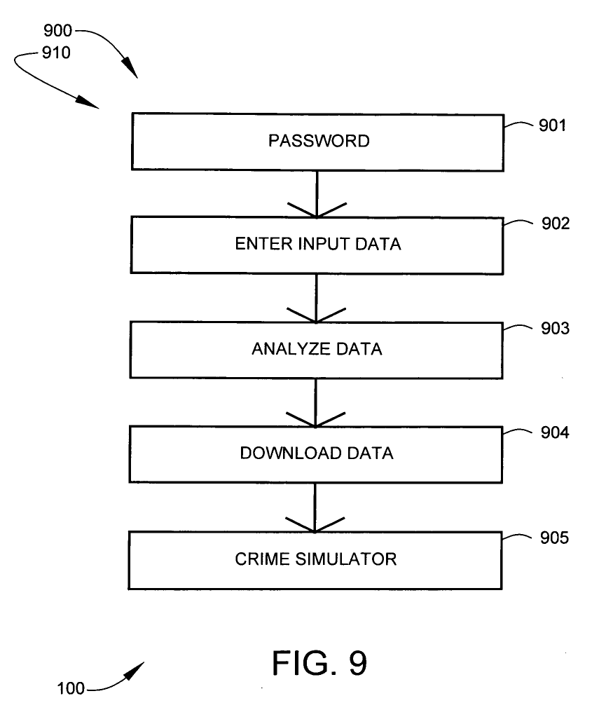

Referring now to FIG. 9 illustrating a preferred method of use 910 of the drawing and data collection system 100, according to a preferred embodiment of the present invention of FIG. 1. Preferred method of use 910 preferably comprises the following steps 901, 902, 903, 904, and 905 as shown on flowchart 900. These and other optional steps are disclosed below.

A method of using a drawing and data collection system comprising the steps of: step one 901, entering at least one user password 111; step two 902 entering input data into software program 127 of a computer with computer system 120 to search and/or optionally retrieve at least one output data 124 from at least one tiered security database that user has authorized access to. The input data 123 and output data 124 may comprise at least one image or text. Next, step three 903 analyzing output data 124 to determine relevance, using flipping and checking functions and optionally filtering/narrowing using statistical profiler 200 and/or observations/hunch notes 202 (if for investigation) to arrive at a manageable final image set; next, step four 904 downloading output data 124 if access is granted, to use in at least one industry-specific drawing, design or simulation test if in an industrial application or to aid in narrowing a field of suspects if being used for an investigation of a crime scene; wherein output data 124 may be used to create at least one crime simulation or user may decide to continue searching and may run various scenarios and/or simulations with or without a witness present. The investigator may turn on or off various links of linker 115 to databases and narrow the search using observations/hunch notes 202 to observe similarities and to compare between statements 159 in text, which may be visualized in color or different font or in oral notes. User may or may not have entered observations/hunch notes 202. Step five 905 may include creating crime scenarios using the crime simulator. Timelines 181 may also be compared to other timelines 181 and to statements 159. Drawings 112 may be made using overlay feature in transparent layers and crime scene may be viewed and modeled using photographs and video of the crime scene. The output search data may be organized comparing facts with crime elements 179 of the presiding law, used for presentation and compared against statistics and cases on record using crime definitions database 180. Drawing and data collection system 100 may be used to acquire statistics using a web crawler or search bot to obtain relevant web/public statistics 116 on internet 122 as published publically available documents and records.

It should be noted that examples have been provided to illustrate various methods that may be used with drawing and data collection system 100 including simulations, creating flowcharts and timelines for investigation and presentation, organizing for investigation and presentation, and tracking.

It should be noted that the steps described in the method of use can be carried out in many different orders according to user preference and may be limited by security tiers to those functions and databases that authorized access has been provided. Upon reading this specification, those with ordinary skill in the art will now appreciate that, under appropriate circumstances, considering such issues as design preference, user preferences, marketing preferences, cost, structural requirements, available materials, technological advances, etc., other methods of use and arrangements such as, for example, different means for inputting and outputting data, inclusion or exclusion of other databases or those listed herein, elimination or addition of certain steps, including or excluding certain options and steps, use of different software, connecting means, security means, use in different applications, etc., may suffice.

It should also be noted that the constitutional laws of the country in which the present invention is used in must be abided by, in order to preserve the integrity and admissibility when retrieving evidence, while respecting the prevailing laws of privacy. As expressed, security and efficiency is of utmost importance to maintain law and order.

From the foregoing description, it should be appreciated that at least one preferred embodiment of drawing and data collection system 100 is provided and presents significant benefits that would be apparent to one skilled in the art. Furthermore, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient framework for implementing a preferred exemplary embodiment of the invention. It being understood that various changes may be made in the function and arrangement of elements described in the exemplary preferred embodiment without departing from the spirit and scope of the invention as set forth in the appended claims.

1. A drawing and data collection system comprising:
at least one computer system;
at least one inputter;
at least one internet communicator;
at least one database comprising at least one security tier and at least one data;
at least one statistical profiler;
wherein said inputter permits at least one user to input data into said at least one computer system which is connected by said at least one internet communicator to said at least one database;
wherein said at least one database comprises at least one data that is searchable by user accessing said at least one security tier; and
wherein said at least one statistical profiler ranks said at least one data according to programmed profiles individuals using weighted statistical links to said at least one database and filters output search data to output at least one image.

2. The drawing and data collection system of claim 1 wherein said drawing and data collection system is used to investigate at least one crime using observations/hunch notes recorded at the crime scene.

3. The drawing and data collection system of claim 1 wherein said drawing and data collection system is used to search and retrieve at least one industry-specific drawing.

4. The drawing and data collection system of claim 1 further comprising at least one crime definitions database for use in searching, preparing, organizing and presenting at least one legal case.

5. The drawing and data collection system of claim 1 further comprising use in combination with at least one virtual globe-map-geographic information program to create at least one simulation of at least one scenario.

6. The drawing and data collection system of claim 1 wherein said at least one database may comprise investigative databases and information comprising:
print/impression databases further comprising,
at least one footprint database,
at least one bite-mark/odontology database,
at least one fingerprint database,
at least one tool-mark database,
at least one tire-tread database, and
at least one forensic document examination database;
weapon databases further comprising,
at least one gun registry database,
at least one ballistics database,
at least one gunpowder residue information/results, and
at least one knife and hand tool database;
at least one individual information databases,
at least one social security number database,
at least one terrorist activities database,
at least one criminal history database,
at least one photograph database,
at least one suspect database,
at least one family tree database,
at least one phone/utility record information,
at least one voice signature database,
at least one economic activity database,
at least one crime family/gang database,
at least one life insurance policy database,
at least one statement; driver's license database,
at least one DNA profile database,
at least one tattoo database,
at least one hospital records,
at least one passport/immigration database,
at least one missing persons database,
at least one street names database, and
at least one ex-offender database;
vehicle information databases further comprising,
at least one vehicle specifications database, and
at least one traffic ticket database;
at least one forensic anthropology/medical examiner database;
at least one forensic archaeology database;
at least one forensic psychology database;
at least one crime definitions database;
at least one timeline;
at least one physics/mathematical formula database;
at least one chemical database;
at least one electronic/computer evidence database;
location information databases further comprising,
at least one geographical map overlay,
at least one topographical overlay,
at least one distance overlay,
at least one GPS locator, and
at least one virtual globe-map-geographic information program;
crime-scene photos;
crime scene videos;
all linked with linker to at least one statistical profiler and observations/hunch notes.

7. The drawing and data collection system of claim 6 wherein said databases are linked with linker according to at least one probability.

8. The drawing and data collection system of claim 1 further comprising at least one overlay procedure means wherein images are referenced against database images and said drawing and data collection system further comprises a means for machine learning to track and record the user's preferences and history.

9. The drawing and data collection system of claim 1 wherein said statistical profiler of drawing and data collection system retrieves said at least one data available to the public using at least one search bot.

10. The drawing and data collection system of claim 6 wherein said physics/mathematical formula database is used to input numerical values to simulate a crime using images and a virtual globe-map-geographic information program.

11. The drawing and data collection system of claim 6 wherein said photograph is downloaded from said photograph database and displayed as at least one photo lineup whereby at least one witness may verify making at least one identification using at least one fingerprint signature.

12. The drawing and data collection system of claim 6 wherein said photograph is downloaded from said photograph database and wherein at least one witness is able to flip through a series of said photographs in a tiled orientation.

13. The drawing and data collection system of claim 6 wherein said statement is compared against another statement and the similarities are visually highlighted using at least one color change in the test.

14. The drawing and data collection system of claim 6 wherein said family tree database and crime family/gang database comprise a set of layered flowcharts that show at least one relationship.

15. The drawing and data collection system of claim 6 wherein said economic activity database is used to monitor passport/immigration database to limit terrorist, gang activities and criminal gain.

16. The drawing and data collection system of claim 6 wherein the software that is used to access the databases is programmed using at least one operating system independent platform.

17. A method of using a drawing and data collection system comprising the steps of:
entering input data into a computer to search and retrieve at least one output data from at least one tiered security database, wherein said at least one data is at least one image or text;
analyzing said output data to determine relevance;
downloading said output data to use in at least one design or investigation;
wherein said output data is used to create at least one crime simulation.

18. The method of using the drawing and data collection system of claim 17 further comprising the step of filtering said at least one output data from at least one tiered security database through a programmed statistical profiler.

19. The method of using the drawing and data collection system of claim 18 further comprising the step of narrowing the search using observations/hunch notes.

20. An accident investigative kit for vehicular accidents comprising:
a digital camera;
a notebook;
a user-instruction manual, and
wherein said digital camera is used to document an accident scene and said notebook is provided to enter information from the scene and said user instruction manual is provided to guide user in documenting said accident scene.
